(19) United States
(12) Patent Application Publication
(10) Pub. No.: US 2013/0231897 A1
(43) Pub. Date: Sep. 5, 2013

(54) SYSTEMS AND METHODS FOR EFFICIENT ANALYSIS OF TOPOGRAPHICAL MODELS

(71) Applicants: J. Harlan Yates, Melbourne, FL (US); Mark Rahmes, Melbourne, FL (US); Robert Haden, Rockledge, FL (US); Patricia Brown, Melbourne, FL (US)

(72) Inventors: J. Harlan Yates, Melbourne, FL (US); Mark Rahmes, Melbourne, FL (US); Robert Haden, Rockledge, FL (US); Patricia Brown, Melbourne, FL (US)

(73) Assignee: HARRIS CORPORATION, Melbourne, FL (US)

(21) Appl. No.: 13/409,601

(22) Filed: Mar. 1, 2012

(51) Int. Cl. G06G 7/48

(52) U.S. Cl. 703/1

(57) ABSTRACT

Systems (100) and methods (300, 3200, 3500) for analyzing topographical models. The methods involve receiving a user input selecting a first content type from a plurality of content types. In response to the reception of the user input, First Model Chips (“FMCs”) are simultaneously generated using terrain elevation data defining a First Topographical Model (“FTM”). Each FMC (1304) comprises at least one of a panned-only view, a zoomed-only view, and a panned-and-zoomed view of FTM (400, 500, 3304, 3306) including at least one item (402-406, 1310) of the first content type that is different from all other items of all other FMCs. Thereafter, a first screen page (1302, 3400) is displayed on a display screen of a computing device. The first screen page comprises a first array (1306, 3404) defined by a plurality of first cells (1308, 3406). Each of the first cells has one of FMCs presented therein.

### BACKGROUND

1. Statement of the Technical Field

The invention concerns computing systems. More particularly, the invention concerns computing systems and methods for efficient analysis of topographical models.

2. Description of the Related Art

A common topographical model is a Digital Elevation Model (“DEM”). A DEM is a sampled matrix representation of a geographical area which may be generated in an automated fashion by a computer. In a DEM, coordinate points are made to correspond with a height value. DEMs are typically used for modeling terrain where the transitions between different elevations (e.g., valleys and mountains) are generally smooth from one to a next. That is, DEMs typically model terrain as a plurality of curved surfaces and any discontinuities therebetween are thus “smoothed” over. In a typical DEM, no distinct objects are present on the terrain. This type of DEM is referred to as a Digital Terrain Model (“DTM”). A DTM is a model that represents a terrain's surface (e.g., the Earth's surface) without any objects on it (e.g., plants and buildings). DEMs are not limited to DTMs. For example, a DEM may also comprise a Digital Surface Model (“DSM”). A DSM is a model that represents a terrain's surface (e.g., the Earth's surface) with all objects on it (e.g., plants and buildings).

There are many known systems that generate DEMs. These systems include, but are not limited to, aerial photography based systems, satellite photography based systems, Electro Optical (“EO”) based systems, Synthetic Aperture Radar (“SAR”) based systems, Light Detection And Ranging (“LiDAR”) based systems, and Geiger-Mode Avalanche PhotoDiode (“GMAPD”) based systems. Each of the listed systems is configured to collect terrain elevation data defining a terrain's surface (e.g., the Earth's surface, the moon's surface or an asteroid's surface). The terrain elevation data defines position measurement values (e.g., longitude and latitude values), height measurement values and correspondences between the same. The terrain elevation data is then processed to generate one or more topographical models, such as DSMs and/or DTMs. Often times, the topographical models comprise surface model errors (e.g., spikes and wells), artifacts, obscurations and voids. Voids may result from the extraction of foliage and/or cultural features (e.g., buildings) from a topographical model, a blind spot of a data collector, and clouds over a geographical area of interest. Therefore, the topographical models are typically analyzed for quality control purposes.

The analysis often involves manually analyzing the topographical models to detect errors which need to be corrected. Such manual analysis is often achieved using a computer executing topographical model analysis software (e.g., ESRI® ArcMap® Geospatial Information System (“GIS”) software, SOCET SET® software, FALCONVIEW® software, computer aided design software, computer aided manufacturing software, and GEOCUE® software). In this scenario, only a portion of a topographical model may be displayed to an operator at any given time. As such, the software provides a pan function and a zoom function. The pan function allows the operator to change a viewport from one part of a topographical model to another part of the topographical model. The zoom function allows the operator to change from a distant view of a topographical model to a more close-up view (zoom in) of the topographical model, and vice versa (zoom out). The pan and zoom operations are typically enabled by the operator using a computer mouse, joy stick and/or gestures.

After the errors are detected via the above described manual process, the errors are manually corrected by the operator. The error detection and correction processes are complex, labor intensive, time consuming, ad hoc and subject to human error. In addition, it is often difficult to assess the cost of performing topographical model processing given variability and quality in various raw source data.

### SUMMARY

Embodiments of the present invention concern implementing systems and methods for efficiently analyzing topographical models. The methods involve receiving a user input selecting a first content type from a plurality of content types. In response to the reception of the user input, a feature analysis plug-in simultaneously generates a plurality of first model chips using terrain elevation data defining a first topographical model. Each of the first model chips comprises at least one of a panned-only view, a zoomed-only view, and a panned-and-zoomed view of the first topographical model including at least one item of the first content type that is different from all other items of all other first model chips. Thereafter, a first screen page is displayed on a display screen of a computing device. The first screen page comprises a first array defined by a plurality of first cells. Each of the first cells has one of the first model chips presented therein.

### BRIEF DESCRIPTION OF THE DRAWINGS

Embodiments will be described with reference to the following drawing figures, in which like numerals represent like items throughout the figures, and in which:

FIG. 1 is a schematic illustration of an exemplary system.

FIG. 2 is a block diagram of an exemplary computing device.

FIGS. 3A-3E collectively provide a flow diagram of an exemplary method for efficient topographical model analysis.

FIG. 4 is a schematic illustration of an exemplary three dimensional (“3D”) topographical model.

FIG. 5 is a schematic illustration of an exemplary two dimensional (“2D”) topographical model.

FIG. 6 is a schematic illustration of an exemplary desktop window.

FIG. 7 is a schematic illustration of an exemplary application window.

FIG. 8 is a schematic illustration of an exemplary drop down menu of an application window.

FIG. 9 is a schematic illustration of an exemplary plug-in window.

FIG. 10A is a schematic illustration of an exemplary toolbar of a plug-in window.

FIGS. 10B-10C each provide a schematic illustration of an exemplary drop down box.

FIG. 11 is a schematic illustration of a concavity scale for classifying terrain of a topographical model.

FIG. 12 is a schematic illustration of terrain parameters useful for classifying terrain of a topographical map.

FIG. 13 is a schematic illustration of an exemplary displayed screen page of model chips.

FIGS. 14, 16 and 18 each provide a schematic illustration of an exemplary selected model chip and menu of commands.

FIGS. 15, 17 and 19 each provide a schematic illustration of at least one exemplary marked model chip.

FIGS. 20 and 22 each provide a schematic illustration of an exemplary screen page of model chips comprising unfilled voids.

FIGS. 21 and 23 each provide a schematic illustration of an exemplary screen page of model chips comprising filled voids.

FIG. 24 is a schematic illustration of an exemplary grey scale color ramp.

FIG. 25 is a schematic illustration of an exemplary color scale color ramp.

FIG. 26 is a schematic illustration of a plurality of exemplary screen pages of sorted model chips.

FIG. 27 is a schematic illustration of an exemplary displayed screen page of sorted model chips.

FIG. 28 is a schematic illustration of an exemplary screen page of filtered model chips.

FIG. 29 is a schematic illustration of an exemplary screen page of sampled model chips.

FIG. 30 is a schematic illustration of an exemplary screen page of “fixed zoomed” model chips.

FIG. 31 is a schematic illustration of an exemplary screen page of “auto zoomed” model chips.

FIG. 32 is a flow diagram of an exemplary method for efficiently analyzing different types of terrain of a topographical model.

FIG. 33 is a schematic illustration of exemplary displayed topographical models.

FIG. 34 is a schematic illustration of an exemplary screen page of model chips.

FIG. 35 is a flow diagram of an exemplary method for efficient terrain and feature data change detection.

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

The present invention concerns implementing systems and methods for efficient analysis of topographical models. The topographical models include, but are not limited to, 2D models and 3D models. In this regard, the present invention implements data driven pan operations, data driven zoom operations, parallel pan/zoom operations for facilitating the simultaneous visual inspection of numerous areas of interest of a topographical model, operations for toggling/flickering between uncorrected topographical models and corrected topographical models, color difference image generation operations, sorting operations for sorting model chips based on attributes thereof (e.g., size and fill accuracy), and filtering operations for filtering model chips based on attributes thereof. The listed operations will become more evident as the discussion progresses. Still, it should be understood that the present invention overcomes various drawbacks of conventional topographical model analysis techniques, such as those described above in the background section of this document. For example, the present invention provides more efficient, less time consuming and less costly data analysis processes as compared to those of conventional topographical model analysis techniques.

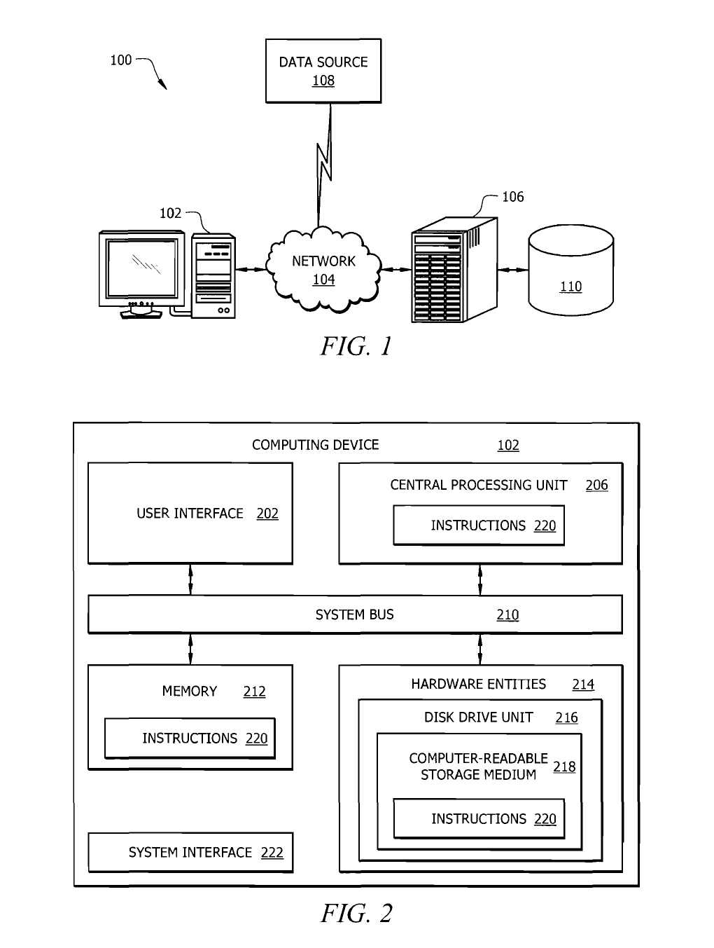

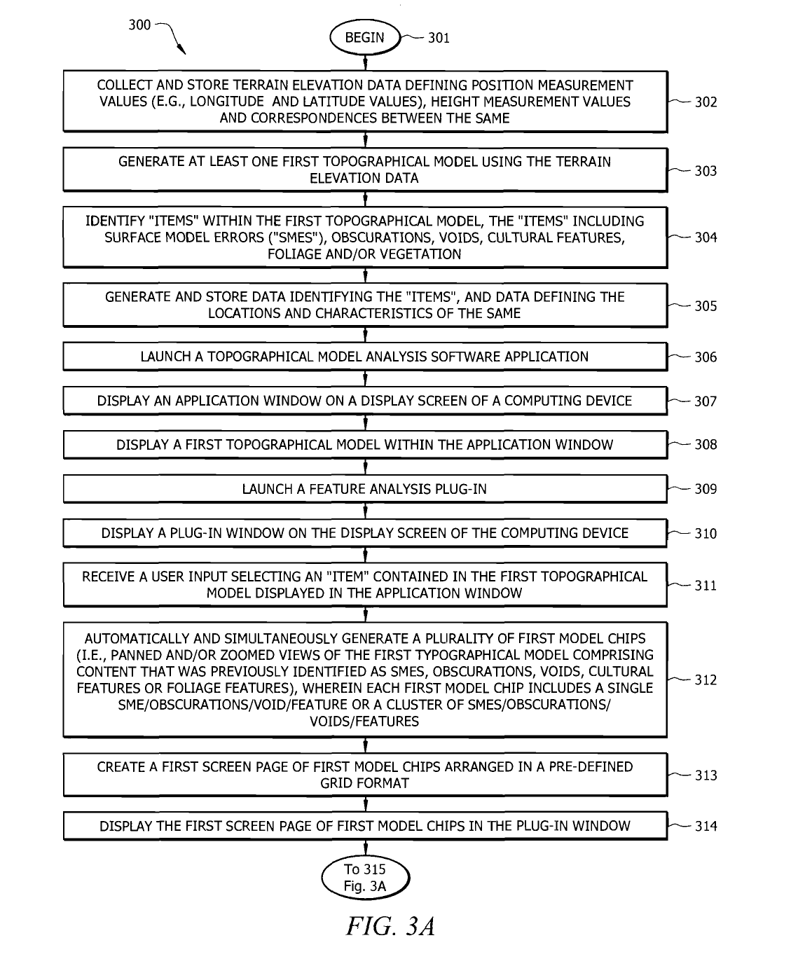

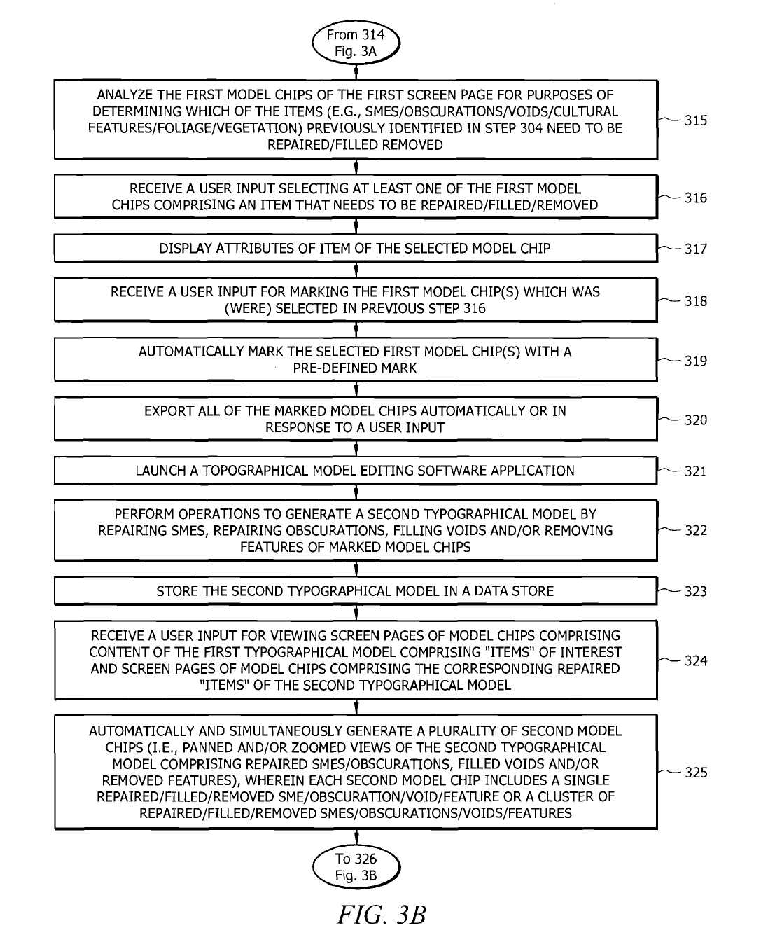

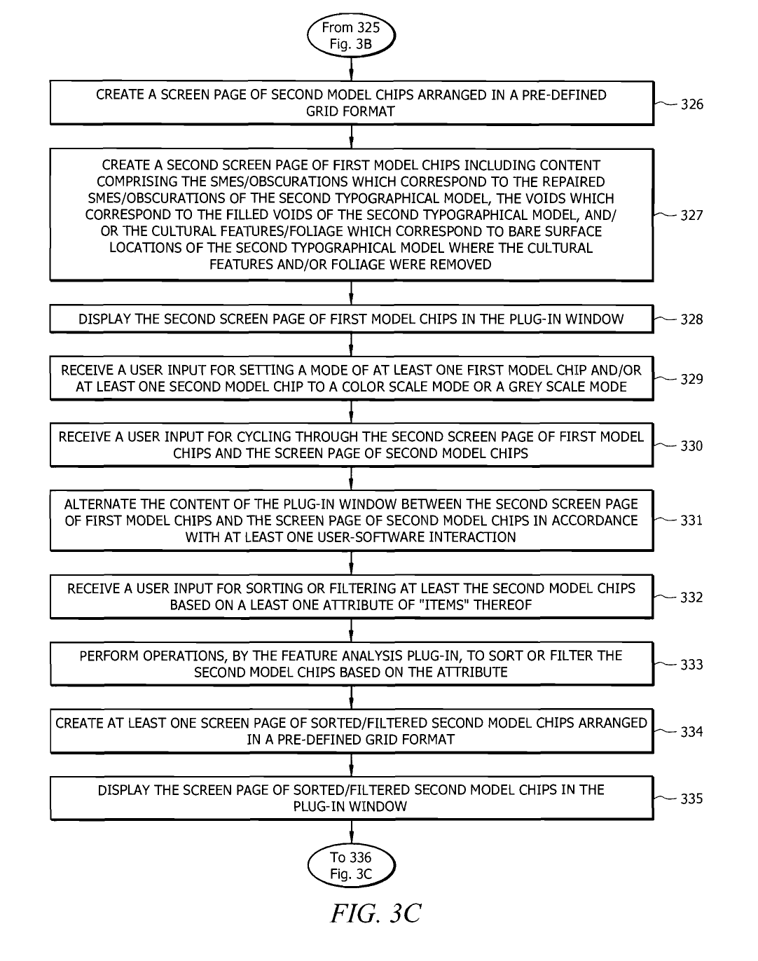

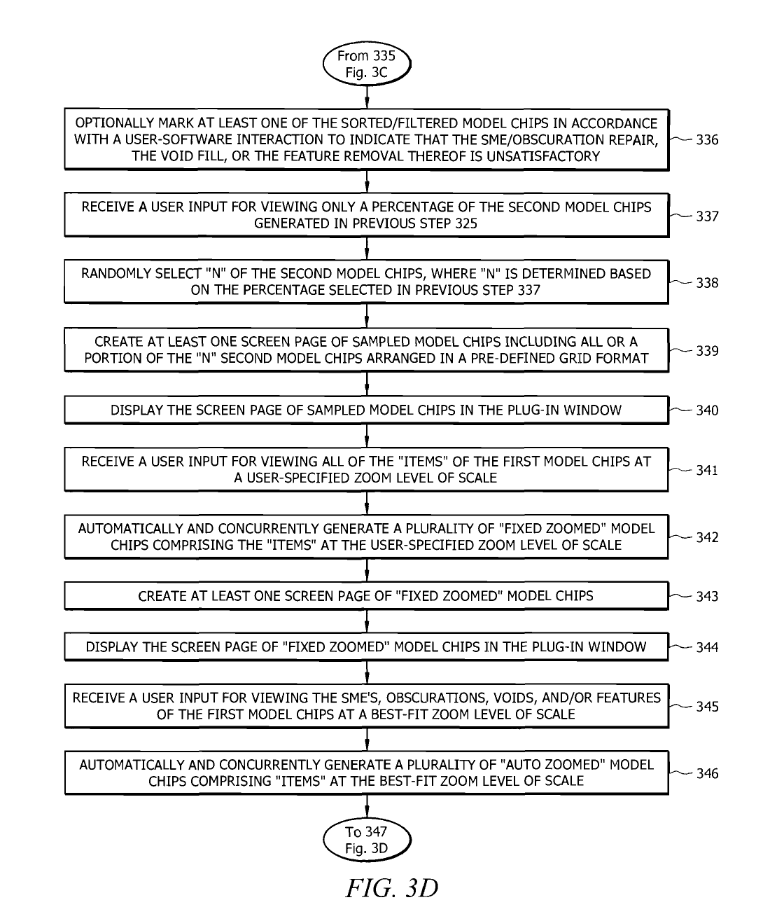

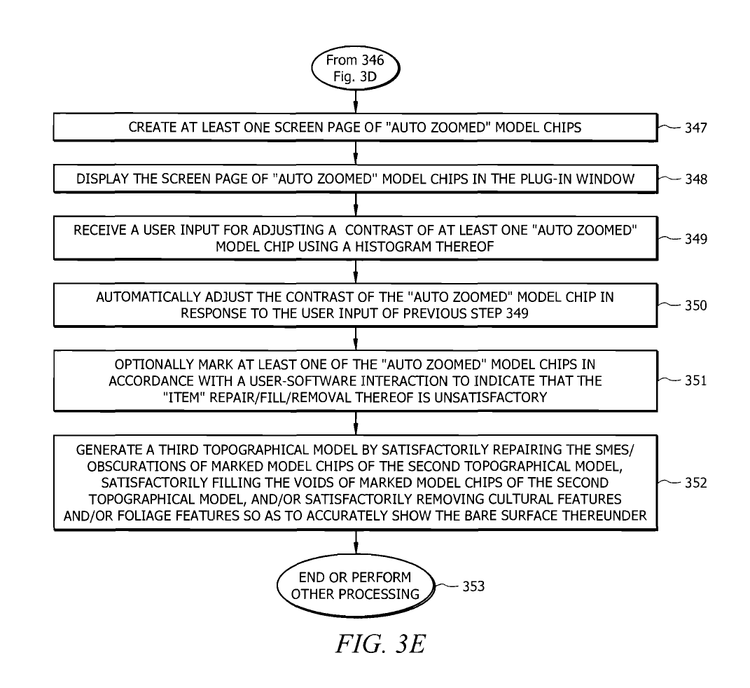

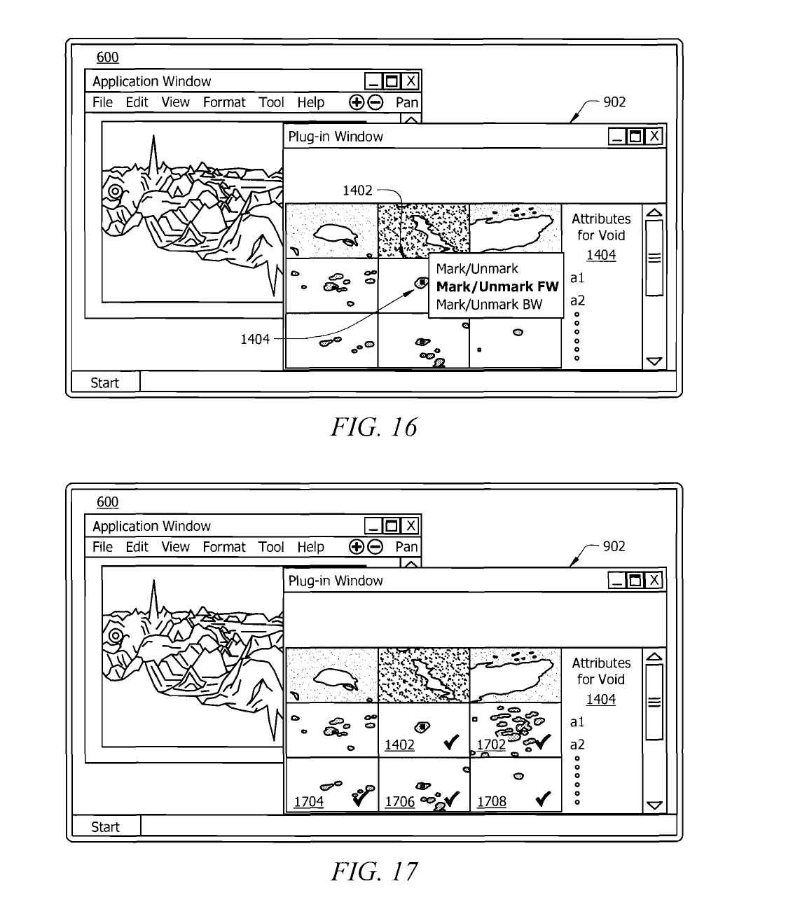

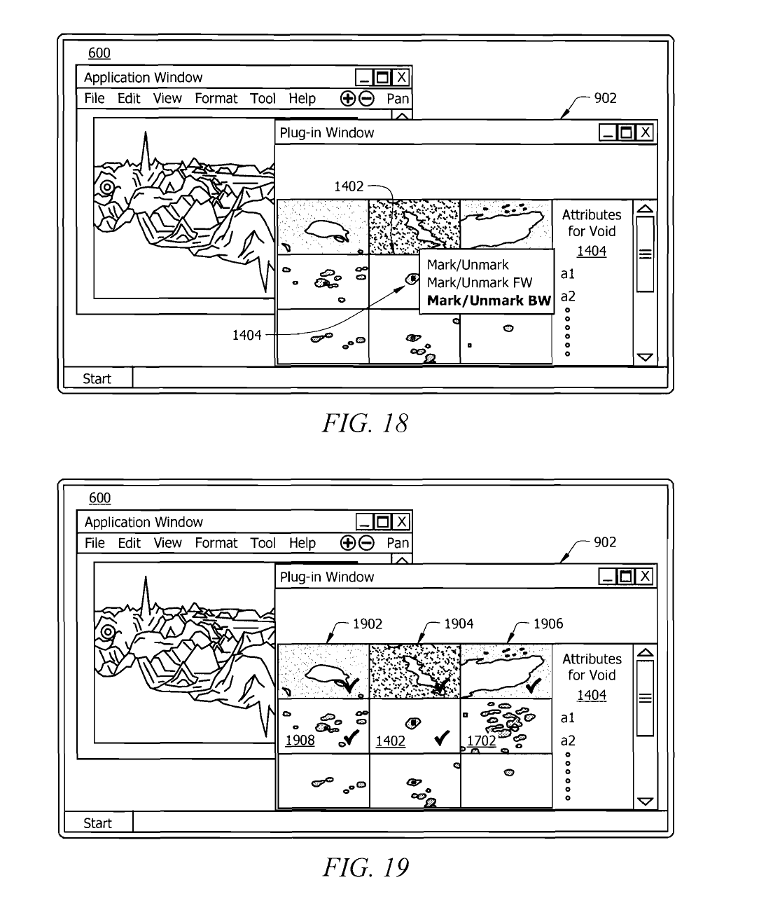

The present invention can be used in a variety of applications. Such applications include, but are not limited to, environmental applications, engineering applications, military applications, and any other application in which topographical models needs to be analyzed, corrected and used. Topographical models are used for a variety of purposes. Such purposes include, but are not limited to, flight simulations, planning military missions, cellular antenna placement, urban planning, and disaster preparedness. Exemplary implementing system embodiments of the present invention will be described below in relation to FIGS. 1, 2, 4, 5, 7, 9, and 10A-12. Exemplary method embodiments of the present invention will be described below in relation to FIGS. 3A-35.

### Exemplary Systems

Referring now to FIG. 1, there is provided a block diagram of an exemplary system 100 that is useful for understanding the present invention. The system 100 comprises a computing device 102, a network 104, a server 106, a data source 108, and at least one data store 110, 112. The system 100 may include more, less or different components than those illustrated in FIG. 1. However, the components shown are sufficient to disclose an illustrative embodiment implementing the present invention.

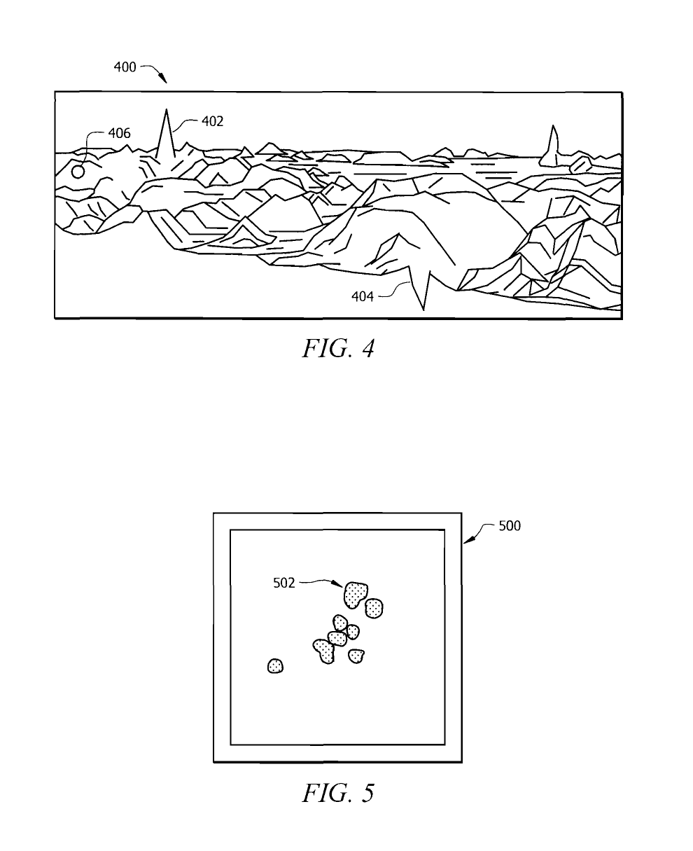

The hardware architecture of FIG. 1 represents one embodiment of a representative system configured to facilitate topographical model analysis for feature display, quality control, and change detection. As such, system 100 implements a method for efficient topographical model analysis in accordance with embodiments of the present invention. The method will be described in detail below in relation to FIGS. 3A-35. However, it should be understood that the method implements a data driven approach for enabling an efficient evaluation of topographical models. The topographical models include, but are not limited to, DSMs and DTMs. Schematic illustrations of exemplary topographical models 400, 500 are provided in FIGS. 4-5. As shown in FIGS. 4-5, the topographical models include, but are not limited to, 2D topographical models and 3D topographical models.

The topographical models and any data associated therewith are stored in data store 110. The data includes, but is not limited to: terrain elevation data defining a terrain's surface (e.g., the Earth's surface, the moon's surface or an asteroid's surface); data identifying Surface Model Errors (“SMEs”), obscurations, voids, cultural features, and foliage; and data defining the locations of SMEs, obscurations, voids, cultural features and foliage within topographical models; and data defining the correspondences between the previously described identifying data and the previously described location data. The terrain elevation data defines position measurement values (e.g., longitude and latitude values), height measurement values, and correspondences between the same. The SMEs include spikes and wells each representing a one pixel error. A schematic illustration of an exemplary spike 402 and an exemplary well 404 is provided in FIG. 4. The obscurations can result from fog, mist, haze, smoke, dust, snow and foliage. The voids can result from the extraction of cultural features and/or foliage from a topographical model. A void is an area of a topographical model comprising an empty set of terrain elevation data. Schematic illustrations of exemplary voids 406, 502 are provided in FIGS. 4-5.

The terrain elevation data can be collected by data source 108. Data source 108 includes any type of Terrain Elevation Data (“TED”) collection system. Such TED collection systems include, but are not limited to, aerial photography based systems, satellite photography based systems, EO based systems, SAR based systems, LIDAR based systems, and GMAPD based systems. The TED collection system may be disposed on or in a satellite, an Unmanned Aerial Vehicle (“UAV”), a plane or a vehicle. Also, the terrain elevation data can be communicated to the data store 110 via network 104 and server 106.

The computing device 102 facilitates topographical model analysis. Accordingly, the computing device 102 has installed thereon a Topographical Model (“TM”) software application and at least one feature analysis plug-in. The TM software application includes, but is not limited to, ESRI® ArcMap® Geospatial Information System (“GIS”) software, SOCET SET® software, FALCONVIEW® software, computer aided design software, computer aided manufacturing software, and GEOCUE® software. Each of the listed TM software applications is well known in the art, and therefore will not be described in detail herein. However, it should be understood that the TM software applications facilitate the display of topographical models in an application window. The TM software applications also facilitate the panning and zooming of the displayed topographical models.

The feature analysis plug-in is a set of software components that adds specific abilities to the TM software application. For example, the feature analysis plug-in provides the ability to: concurrently and/or simultaneously generate a plurality of model chips using terrain elevation data defining a topographical model; and display all or a portion of the generated model chips in a display area of a plug-in window at the same time. The phrase “model chip”, as used herein, refers to a panned view and/or a zoomed view of a topographical model. A model chip may include, but is not limited to, a visual representation of an SME, an obscuration, a void, a cultural feature, foliage, vegetation, a particular type of terrain (e.g., sinkhole, trench, ridge and mound), and/or a difference indication indicating a change of a scene's content. The term “cultural feature”, as used herein, refers to a representation of an object. Such objects include, but are not limited to, manmade objects (e.g., bridges, water towers, boats, planes, roads, lakes, buildings, gas stations, restaurants, malls, stores, vehicles, and cisterns).

Notably, the model images may be displayed in the plug-in window in a grid format or a matrix format. In the grid scenario, each cell of a grid includes one model chip. As a result of such a grid arrangement of model chips, a user can perform topographical model analysis in a shorter period of time as compared to that needed to perform a topographical model analysis using the conventional technique employed by the TM software applications. This conventional technique generally involves manually panning and zooming to each instance of an SME, obscuration, void, cultural feature, foliage, vegetation, type of terrain, and/or difference indication.

Referring now to FIG. 2, there is provided a block diagram of an exemplary embodiment of the computing device 102. The computing device 102 can include, but is not limited to, a notebook, a desktop computer, a laptop computer, a personal digital assistant, and a tablet PC. The server 106 of FIG. 1 can be the same as or similar to computing device 102. As such, the following discussion of computing device 102 is sufficient for understanding server 106 of FIG. 1. Notably, some or all the components of the computing device 102 can be implemented as hardware, software and/or a combination of hardware and software. The hardware includes, but is not limited to, one or more electronic circuits.

Notably, the computing device 102 may include more or less components than those shown in FIG. 2. However, the components shown are sufficient to disclose an illustrative embodiment implementing the present invention. The hardware architecture of FIG. 2 represents one embodiment of a representative computing device configured to facilitate topographical model analysis in an efficient manner. As such, the computing device 102 of FIG. 2 implements improved methods for topographical model analysis in accordance with embodiments of the present invention.

As shown in FIG. 2, the computing device 102 includes a system interface 222, a user interface 202, a Central Processing Unit (“CPU”) 206, a system bus 210, a memory 212 connected to and accessible by other portions of computing device 102 through system bus 210, and hardware entities 214 connected to system bus 210. At least some of the hardware entities 214 perform actions involving access to and use of memory 212, which can be a Random Access Memory (“RAM”), a disk driver and/or a Compact Disc Read Only Memory (“CD-ROM”).

System interface 222 allows the computing device 102 to communicate directly or indirectly with external communication devices (e.g., server 106 of FIG. 1). If the computing device 102 is communicating indirectly with the external communication device, then the computing device 102 is sending and receiving communications through a common network (e.g., the network 104 shown in FIG. 1).

Hardware entities 214 can include a disk drive unit 216 comprising a computer-readable storage medium 218 on which is stored one or more sets of instructions 220 (e.g., software code) configured to implement one or more of the methodologies, procedures, or functions described herein. The instructions 220 can also reside, completely or at least partially, within the memory 212 and/or within the CPU 206 during execution thereof by the computing device 102. The memory 212 and the CPU 206 also can constitute machine-readable media. The term “machine-readable media”, as used here, refers to a single medium or multiple media (e.g., a centralized or distributed database, and/or associated caches and servers) that store the one or more sets of instructions 220. The term “machine-readable media”, as used here, also refers to any medium that is capable of storing, encoding or carrying a set of instructions 220 for execution by the computing device 102 and that cause the computing device 102 to perform any one or more of the methodologies of the present disclosure.

In some embodiments of the present invention, the hardware entities 214 include an electronic circuit (e.g., a processor) programmed for facilitating efficient topographical model analysis through data-driven spatial sampling and data-driven spatial re-expansion of terrain elevation data. In this regard, it should be understood that the electronic circuit can access and run TM software applications (not shown in FIG. 2), feature analysis plug-ins (not shown in FIG. 2) and other types of applications installed on the computing device 102. The TM software applications are generally operative to facilitate the display of topographical models in an application window, the panning of displayed topographical models, and the zooming of displayed topographical models. The listed functions and other functions implemented by the TM software applications are well known in the art, and therefore will not be described in detail herein. A schematic illustration of an exemplary application window 704 is provided in FIG. 7.

The feature analysis plug-ins are generally operative to display a plug-in window on a display screen of the computing device 102. A schematic illustration of an exemplary plug-in window 902 is provided in FIG. 9. Various types of information can be presented in the plug-in window. Such information includes, but is not limited to, model chips and attribute information. The attribute information can include, but is not limited to, SME characteristics, obscuration characteristics, accuracy metrics, void sizes, prediction errors, maximum height statistical values, minimum height statistical values, void characteristics (e.g., 3D void perimeter complexity characteristics), foliage characteristics, vegetation characteristics, terrain characteristics, scene change characteristics, and information describing attributes of an object which a cultural feature visually represents (e.g., heights, lengths, diameters, longitudes, latitudes, addresses, names, and text).

The feature analysis plug-ins are also operative to perform one or more of: automatically and simultaneously generate a plurality of model chips in response to a user software interaction; generate at least one screen page of model chips arranged in a grid or matrix format; display screen pages of model chips in a plug-in window; update a view of a topographical model displayed in an application window to show at least the visual contents of a selected one of a plurality of model chips displayed in a plug-in window; sort a plurality of model chips based on at least one attribute of the contents thereof; generate and display at least one screen page of model chips which are arranged in a sorted order; filter model chips based on at least one attribute of the contents thereof; randomly select and display only a percentage of a plurality of model chips; change a grid size in response to a user software interaction; change a zoom level of scale or resolution of displayed model chips in response to a user software interaction; pan a topographical model displayed in an application window such that the content of a model chip displayed in a plug-in window is shown in the application window; zoom a topographical model displayed in an application window such that the content of a model chip is shown at a particular zoom resolution within the application window; cycle through screen pages of model chips that were generated using a plurality of topographical maps; generate and display model chips comprising areas that are common to two or more topographical models; mark model chips in response to user software interactions; unmark model chips in response to user software interactions; setting a mode of a model chip to a color scale mode or a grey scale mode in response to a user-software interaction; adjusting a contrast of a model chip using a histogram thereof in response to a user-software interaction; and remember various settings that a user sets for each content class (e.g., SMEs, obscurations, voids, foliage, vegetation, terrain, cultural features and difference indications) bridges, water towers and gas stations) during at least one session. The listed functions and other functions of the feature analysis plug-ins will become more apparent as the discussion progresses. Notably, one or more of the functions of the feature analysis plug-ins can be accessed via a toolbar, menus and other Graphical User Interface (“GUI”) elements of the plug-in window.

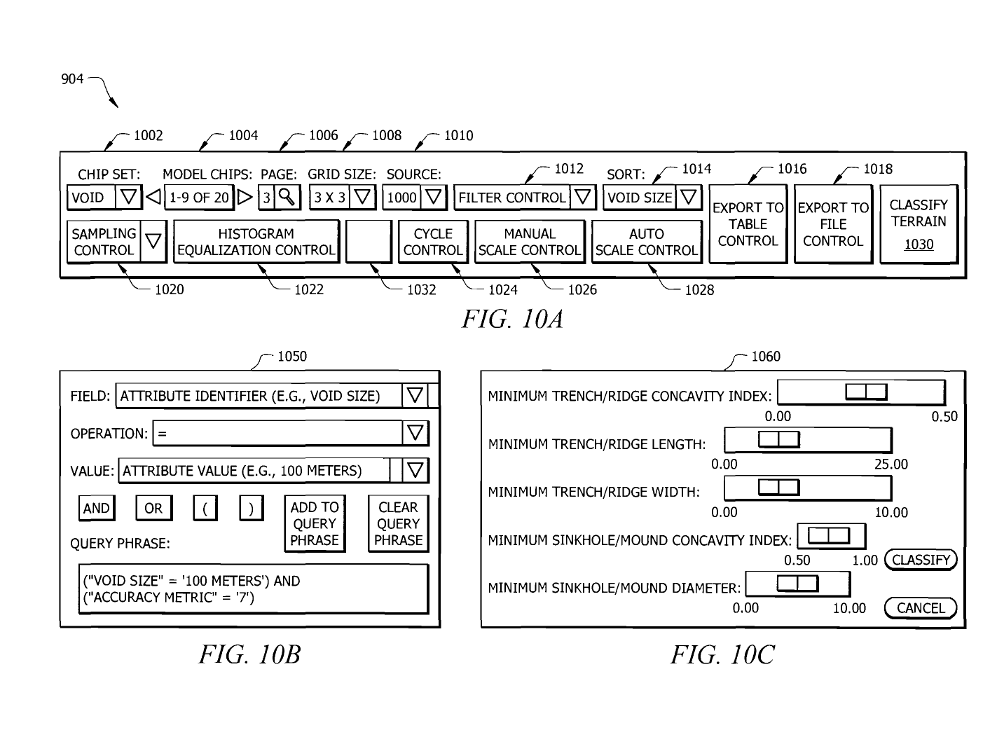

A schematic illustration of an exemplary toolbar 1004 of a plug-in window (e.g., plug-in window 902 of FIG. 9) is provided in FIG. 10A. As shown in FIG. 10A, the toolbar 1004 comprises a plurality of exemplary GUI widgets 1002-1032. Each of the GUI widgets 1002-1032 is shown in FIG. 10A as a particular type of GUI widget. For example, GUI widget 1002 is shown as a drop down menu. Embodiments of the present invention are not limited in this regard. The GUI widgets 1002-1032 can be of any type selected in accordance with a particular application.

GUI widget 1002 is provided to facilitate the display of an array of model chips including content of a user selected content class (e.g., SMEs, obscurations, voids, foliage, vegetation, terrain, cultural features, or difference indication) and/or a user selected content sub-class. Terrain sub-classes can include, but are not limited to, a sinkhole sub-class, a trench sub-class, a hyperbolic terrain sub-class, a planar terrain sub-class, a ridge sub-class, and a mound sub-class. Cultural feature sub-classes can include, but are not limited to, a bridge sub-class, a building sub-class, and a water tower sub-class. Difference indication sub-classes can include, but are not limited to, positive elevation changes, negative elevation changes, matched content, new content, and deleted content. The array of model chips is displayed in the display area (e.g., display area 906 of FIG. 9) of the plug-in window (e.g., plug-in window 902 of FIG. 9) in a grid format. In the embodiment shown in FIG. 10A, the GUI widget 1002 includes, but is not limited to, a drop down list that is populated with the content classes identified in a previously generated content list. Drop down lists are well known in the art, and therefore will not be described herein.

GUI widget 1004 is provided to facilitate moving through screen pages of model chips associated with a single content class. If a selected content class has more than the maximum number of individual items and/or clusters of items that can fit in a grid of a selected grid size (e.g., three cells by three cells), then the feature analysis plug-in generates a plurality of screen pages of model chips. Each screen page of model chips includes a grid with model chips contained in the cells thereof. As shown in the embodiment of FIG. 10A, the GUI widget 1004 includes, but is not limited to, a text box, a forward arrow button and a backward arrow button. Text boxes and arrow buttons are well known in the art, and therefore will not be described herein. This configuration of the GUI widget 1004 allows a user to move forward and backward through the screen pages of model chips associated with a single topographical model. Paging forward or backward will cause the model chip in an upper left corner grid cell of the new screen page to be selected. The screen page context is displayed in the text box as the numerical range of model chips displayed (e.g., model chips one through nine) and the total number of model chips (e.g., twenty) providing visual representations of items of a selected content class.

GUI widget 1006 is provided to facilitate jumping to a desired screen page of model chips for review. As shown in the embodiment of FIG. 10A, GUI widget 1006 includes, but is not limited to, a text box and a search button. The text box is a box in which to enter a screen page number (e.g., three). Clicking the search button will cause the screen page of model chips having the entered screen page number to be displayed in the display area (e.g., display area 906 of FIG. 9) of the plug-in window (e.g., plug-in window 902 of FIG. 9).

GUI widget 1008 is provided to facilitate a selection of a grid size from a plurality of pre-defined grid sizes. As shown in FIG. 10A, the GUI widget 1008 includes, but is not limited to, a drop down list listing a plurality of pre-defined grid sizes. In some embodiments, the pre-defined grid sizes include one cell by one cell, two cells by two cells, three cells by three cells, four cells by four cells, five cells by five cells, six cells by six cells, seven cells by seven cells, eight cells by eight cells, nine cells by nine cells, and ten cells by ten cells. The grid size of two cells by two cells ensures that a maximum of four model chips will be simultaneously or concurrently displayed in the display area of the plug-in window. The grid size of three cells by three cells ensures that a maximum of nine model chips will be simultaneously or concurrently displayed in the display area of the plug-in window. The grid size of four cells by four cells ensures that a maximum of sixteen model chips will be simultaneously or concurrently displayed in the display area of the plug-in window. The grid size of five cells by five cells ensures that a maximum of twenty-five model chips will be simultaneously or concurrently displayed in the display area of the plug-in window. The grid size of six cells by six cells ensures that a maximum of thirty-six model chips will be simultaneously or concurrently displayed in the display area of the plug-in window. The grid size of seven cells by seven cells ensures that a maximum of forty-nine model chips will be simultaneously or concurrently displayed in the display area of the plug-in window. The grid size of eight cells by eight cells ensures that a maximum of sixty-four model chips will be simultaneously or concurrently displayed in the display area of the plug-in window. The grid size of nine cells by nine cells ensures that a maximum of eight-one model chips will be simultaneously or concurrently displayed in the display area of the plug-in window. The grid size of ten cells by ten cells ensures that a maximum of one hundred model chips will be simultaneously or concurrently displayed in the display area of the plug-in window. Embodiments of the present invention are not limited to grid having an equal number of cells in the rows and columns thereof. For example, a grid can alternatively have a grid size of four cells by three cells such that each column thereof comprises four cells and each row thereof comprises three cells, or vice versa.

Notably, the display area for each model chip is different for each grid size. For example, the display area for each model chip in a grid having a grid size of two cells by two cells is larger than the display area for each model chip in a grid having a grid size of three cells by three cells. Also, if each model chip has the same zoom level of scale or resolution, then the portion of a topographical model contained in a model chip displayed in a two cell by two cell grid is larger than the portion of a topographical model contained in a model chip displayed in a three cell by three cell grid. It should also be noted that, in some embodiments, a selected model chip of a first grid will reside in an upper left corner cell of a second grid having an enlarged or reduced grid size.

GUI widget 1012 is provided to facilitate a selection of content for display in the display area (e.g., display area 706 of FIG. 7) of the plug-in window (e.g., plug-in window 702 of FIG. 7) based on its attributes. As shown in FIG. 10A, the GUI widget 1012 includes a “filter control” button and a “filter setting” drop down button. The “filter control” button facilitates the enablement and disablement of an attribute filter function of the feature analysis plug-in. The “filter setting” drop down button facilitates the display of a drop-down box for assembling a query phrase defining an attribute filter (e.g., [“HEIGHT”=‘100 Feet’], [“HEIGHT”<‘100 Feet’], [“HEIGHT”< >‘100 Feet’], [“HEIGHT” IS NULL], [“HEIGHT” IS NOT NULL], [“HEIGHT”≧‘100 Feet’ AND “DIAMETER”>‘40 Feet’], [“HEIGHT”≦‘100 Feet’ OR “DIAMETER”>‘40 Feet’], [“CONCAVITY INDEX”≦‘0.50’], [“WIDTH”≦‘10 Meters’], [“VOID SIZE”≧‘5 Meters’], [“VOID FILL ACCURACY”≧‘8’], [“VOLUMETRIC DIFFERENCE OF EACH VOID”=‘0.2 Meters’], or [“VOID AREA”≧‘10 Meters’]). A schematic illustration of an exemplary drop-down box 1050 is provided in FIG. 10B. When the attribute filter function is enabled, the query phrase takes effect immediately.

Notably, the feature analysis plug-in remembers the filter query phrase that a user sets for each content class and/or content sub-class during a session. Accordingly, if the user changes a content class or a content sub-class from a first content class or sub-class (e.g., SMEs) to a second content class or sub-class (e.g., voids) during a session, then the previously set filter query for the second content class or sub-class will be restored. Consequently, only items of the second content class or sub-class (e.g., voids) which have the attribute specified in the previously set filter query (e.g., “VOID FILL ACCURACY”≧‘8’) will be displayed in the plug-in window.

GUI widget 1014 is provided to facilitate the sorting of model chips based on one or more attributes of the items contained therein. For example, a plurality of model chips are sorted into an ascending or descending order based on the heights and/or diameters of sinkholes visually represented by the content contained therein. As shown in FIG. 10A, the GUI widget 1014 includes a drop down list. Embodiments of the present invention are not limited in this regard. For example, the GUI widget 1014 can alternatively include a button and a drop down arrow for accessing a drop down box. The button facilitates the enablement and disablement of a sorting function of the feature analysis plug-in. The drop down box allows a user to define settings for sorting model chips based on one or more attributes of an active content class. As such, the drop down box may include a list from which an attribute can be selected from a plurality of attributes. The drop down box may also include widgets for specifying whether the model chips should be sorted in an ascending order or a descending order.

Notably, the feature analysis plug-in remembers the sort settings that a user defines for each content class and/or content sub-class during a session. Accordingly, if the user changes a content class or sub-class from a first content class or sub-class (e.g., SMEs) to a second feature class (e.g., obscurations) during a session, then the previously defined sort settings for the second content class or sub-class will be restored. Consequently, model chips containing items of the second content class or sub-class (e.g., obscurations) will be displayed in a sorted order in accordance with the previously defined sort settings.

GUI widget 1020 is provided to facilitate the display of a random sample of model chips of items of a particular content class for visual inspection and quality control testing. As such, the GUI widget 1020 includes, but is not limited to, a button for enabling/disabling a random sampling function of the feature analysis plug-in and a drop down menu from which a percentage value can be selected.

GUI widget 1022 is provided to facilitate the toggling of histogram stretch of model chips on and off. Histogram stretch leads to brighter and higher-contrast imagery. Accordingly, histogram stretch is achieved by adjusting the global contrasts of model chips or topographical models using histograms thereof. As such, the GUI widget 1022 includes, but is not limited to, a button for enabling and disabling a histogram stretch function of the feature analysis plug-in. Histogram stretch is well known in the art, and therefore will not be described herein. Still, it should be understood that histogram stretch can be turned on and off for terrain elevation data and/or for imagery.

GUI widget 1032 is provided to facilitate the filtering of features which lie outside of an area (e.g., a geographical area) defined either by the area that a plurality of topographical models have in common or by the area covered by a plurality of topographical models taken together. As such, the GUI widget 1032 includes, but is not limited to, a button for enabling and disabling an intersection function of the feature analysis plug-in.

GUI widget 1010 is provided to facilitate the selection of a topographical model from a plurality of topographical models. As shown in FIG. 10A, the GUI widget 1010 includes, but is not limited to, a text box and a drop down list populated with the names of topographical models. If a user selects a new item from the drop down list, then the feature analysis plug-in generates and displays at least one screen page of model chips using the topographical model identified by the newly selected item. The model chips contain items of the same content class as the immediately preceding displayed model chips. The text box displays information identifying the topographical model from which the currently displayed model chips were generated. The contents of the text box can be updated in response to a user selection of a new item from the drop down list. The contents of the text box can also be updated by the feature analysis plug-in during the performance of topographical model cycling operations, which will be described below in relation to GUI widget 1024. Accordingly, the information contained in the text box always identifies the topographical model from which the currently displayed model chips were generated.

GUI widget 1024 is provided to facilitate the cycling through screen pages of model chips for a plurality of topographical models. A user may want to cycle through such screen pages for change detection purposes. The GUI widget 1024 is configured to allow manual cycling and/or automatic cycling between screen pages for a plurality of topographical models. As such, the GUI widget 1024 includes, but is not limited to, a check box for enabling and disabling topographical model cycling operations of the feature analysis plug-in, a slider for setting the rate at which the topographical models automatically cycle, and/or a button for manually commanding when to change the topographical model.

GUI widget 1026 is provided to facilitate the performance of manual-scale operations by the feature analysis plug-in. The manual-scale operations are operative to adjust the zoom level of scale of all of the displayed model chips from a first zoom level of scale to a second zoom level of scale in response to a user-software interaction. The first zoom level of scale is a default zoom level of scale (e.g., 100%) or a previously user-selected zoom level of scale (e.g., 50%). The second zoom level of scale is a new user-selected zoom level of scale (e.g., 75%). As such, the GUI widget 1926 includes, but is not limited to, a drop down list populated with a plurality of whole number percentage values. The percentage values include, but are not limited to, whole number values between zero and one hundred.

GUI widget 1028 is provided to facilitate the viewing of each displayed item at its best-fit zoom level of scale or its pre-defined maximum zoom level of scale. As such, the GUI widget 1028 includes, but is not limited to, a button for enabling and disabling auto-scale operations of the feature analysis plug-in. When the auto-scale operations are enabled, the manual-scale operations are disabled. Similarly, when the auto-scale operations are disabled, the manual-scale operations are enabled.

GUI widget 1016 is provided to facilitate the writing of all “marked” model chips to an output file stored in a specified data store (e.g., data store 110 of FIG. 1). GUI widget 1018 is provided to facilitate the saving of all model chips which have been “marked” during a session to a user-named file. The user-named file can include, but is not limited to, a shapefile. Shapefiles are well known in the art, and therefore will not be described herein. In some embodiments of the present invention, a model chip is “marked” by right clicking on the model chip to obtain access to a “chip context” GUI and selecting a “mark” item from the “chip context” GUI.

GUI widget 1030 is provided to facilitate the classification of terrain of a first topographical model and the generation of a second topographical model clearly distinguishing the different types of terrain visually represented in the first topographical model. The types of terrain can be distinguished by color coding terrain elevation data of a topographical map in accordance with a defined color scheme. Methods for color coding terrain elevation data are well known in the art, and therefore will not be described herein. However, it should be understood that any known method for color coding terrain elevation data can be used with the present invention without limitation. One such method generally involves: calculating a shape index of each post using interpolated surface normals of each point; determining a size of each patch to be interpolated; thresholding a concavity index to classify each post; segmenting the posts into groups; and culling insignificant feature groups; and creating a polygon shapefile.

As shown in FIG. 10A, the GUI widget 1030 includes, but is not limited to, a button for enabling and disabling terrain classification functions of the feature analysis plug-in. In response to the depression of the button a drop down box is presented to the user of the computing device 102. The drop down box is provided to allow a user to set certain parameters for terrain classification. A schematic illustration of an exemplary terrain classification drop down box 1060 is provided in FIG. 10C. As shown in FIG. 10C, the drop down box 1060 includes a plurality of GUI widgets for defining a minimum trench/ridge concavity index value, a minimum trench/ridge length value, a minimum trench/ridge width value, a minimum sinkhole/mound concavity index value, and a minimum sinkhole/mound diameter value. The drop down box also comprises a GUI widget for initiating the performance of the terrain classification functions of the feature analysis plug-in. Embodiments of the present invention are not limited to the particularities of FIG. 10C.

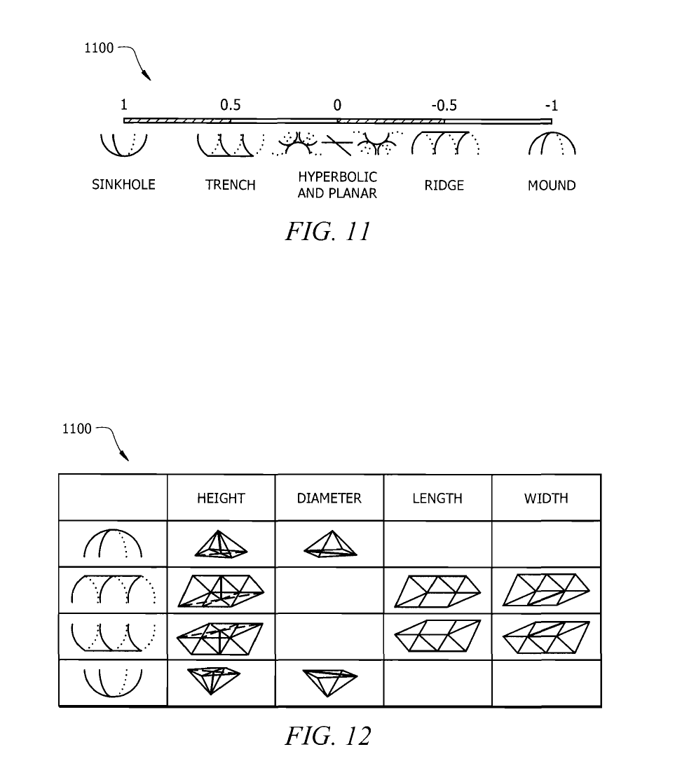

An exemplary color scheme employed by the feature analysis plug-in is schematically illustrated in FIGS. 11-12. As shown in FIGS. 11-12, different types of terrain are classified into a plurality of categories based on the concavity index, height, diameter, length and/or width thereof. For example, terrain having a concavity index of one, a pre-defined height, and a pre-defined diameter is classified as a sinkhole. Terrain having a concavity index of one half, a pre-defined height, a pre-defined length and a pre-defined width is classified as a trench. Terrain having a concavity index of zero is classified as hyperbolic terrain or planar terrain. Terrain having a concavity index of negative one half, a pre-defined height, a pre-defined length and a pre-defined width is classified as a ridge. Terrain having a concavity index of negative one, a pre-defined height and a pre-defined diameter is classified as a mound. After the terrain has been classified into a plurality of terrain categories, the second typographical model is generated by color coding the terrain elevation data of the first topographical map. For example, red coded terrain elevation data represents a sinkhole. Yellow coded terrain elevation data represents a trench. Green coded terrain elevation data represents hyperbolic terrain or planar terrain. Blue coded terrain elevation data represents a ridge. Purple coded terrain elevation data represents a mound. Once all of the terrain elevation data has been color coded, the second topographical map is generated and displayed in a plug-in window. Embodiments of the present invention are not limited to the particularities of FIGS. 11-12.

As evident from the above discussion, the system 100 implements one or more method embodiments of the present invention. The method embodiments of the present invention provide implementing systems with certain advantages over conventional topographical model analysis systems. For example, the present invention provides a system in which an analysis of topographical models can be performed in a shorter period of time as compared to the amount of time needed to analyze topographical models using conventional pan/zoom techniques. The present invention also provides a system in which topographical models are analyzed much more efficiently than in conventional topographical model analysis systems. The manner in which the above listed advantages of the present invention are achieved will become more evident as the discussion progresses.

### Exemplary Methods

Referring now to FIGS. 3A-3E, there is provided a flow diagram of an exemplary method 300 for efficient topographical model analysis that is useful for understanding the present invention. As shown in FIG. 3A, the method 300 begins with step 301 and continues with step 302. In step 302, terrain elevation data is collected. The terrain elevation data can include, but is not limited to, data defining position measurement values (e.g., longitude values and latitude values), height measurement values and correspondences between the position measurement values and the height measurement values. After the terrain elevation data is collected, it is stored in a data store (e.g., data store 110 of FIG. 1) that is accessible by a computing device (e.g., computing device 102 of FIG. 1), as also shown by step 302.

In a next step 303, the terrain elevation data is processed to generate at least one first topographical model. Schematic illustrations of exemplary topographical models 400, 500 are provided in FIGS. 4-5. Methods for generating topographical models based on terrain elevation data are well known in the art, and therefore will not be described herein. However, it should be understood that any such method can be used with the present invention without limitation. One such method that can be employed by the present invention is described in U.S. Pat. No. 6,654,690 to Rahmes et al.

Once the first topographical model has been generated, it is analyzed for purposes of identifying SMEs, obscurations, voids, cultural features, foliage and/or vegetation therein, as shown by step 304. Methods for identifying SMEs, obscurations, voids, cultural features, foliage and/or vegetation within a topographical model are well known in the art, and therefore will not be described herein. Any such method can be used with the present invention without limitation. One such method for identifying voids within a topographical model is described in U.S. Patent Publication No. 2008/0319723 to Smith et al. An exemplary method for identifying SMEs (e.g., spikes and wells) within a topographical model is described in U.S. Pat. No. 7,376,513 to Rahmes et al.

Referring again to FIG. 3A, the method 300 continues with step 305 where data is generated and stored in a data store (e.g., data store 110 of FIG. 1). The data can include, but is not limited to: data identifying SMEs, obscurations, voids, cultural features, foliage and vegetation of a topographical model; and data defining the locations and characteristics of the SMEs, obscurations, voids, cultural features, foliage and vegetation of a topographical model. Step 305 can also involve generating a list of content categories identifying the types of content contained in the topographical model. For example, the list can include, but is not limited to, the following content categories: SME; obscuration; void; cultural feature; foliage; and/or vegetation. This list of content categories will be subsequently used by a feature analysis plug-in to allow a user to select a particular type of content to analyze at any given time.

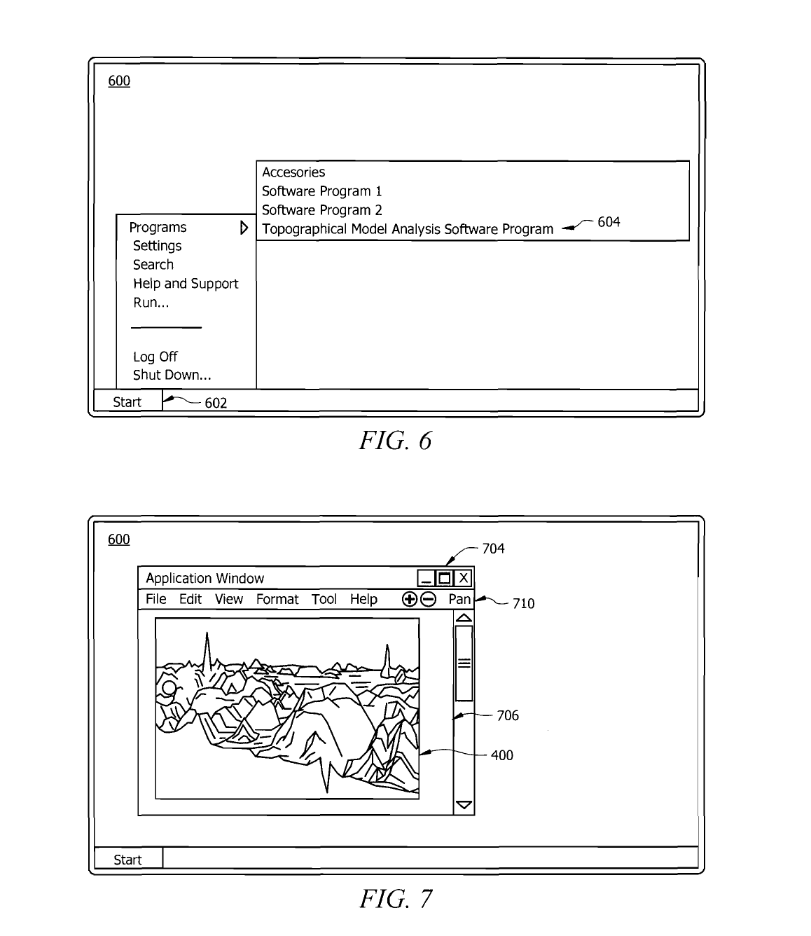

In a next step 306, a TM analysis software application is launched. The TM software application can be launched in response to a user software interaction. For example, as shown in FIG. 6, a TM software application can be launched by accessing and selecting a “Topographical Model Analysis Software Program” entry 604 on a start menu 602 of a desktop window 600.

In a next step 307, an application window is displayed on top of the desktop window. A schematic illustration of an exemplary application window is provided in FIG. 7. As shown in FIG. 7, the application window 704 includes a toolbar 710 including GUI widgets for at least displaying a topographical model, panning a topographical model, zooming a topographical model, and launching a plug-in. The application window 704 also includes a display area 706 in which a topographical model can be presented to a user of the computing device (e.g., computing device 102 of FIG. 1).

Referring again to FIG. 3A, a topographical model is displayed in the application window, as shown in step 308. A schematic illustration showing an exemplary topographical model 400 of FIG. 4 displayed in an application window 704 is provided in FIG. 7. As shown in FIGS. 4 and 7, the topographical model 400 contains a plurality of items. The items include spikes 402, wells 404 and voids 406. Notably, data defining the items may be color coded such that the items are visually distinguishable from other content of the topographical model 400. For example, the items are presented in purple and all other content is presented in green.

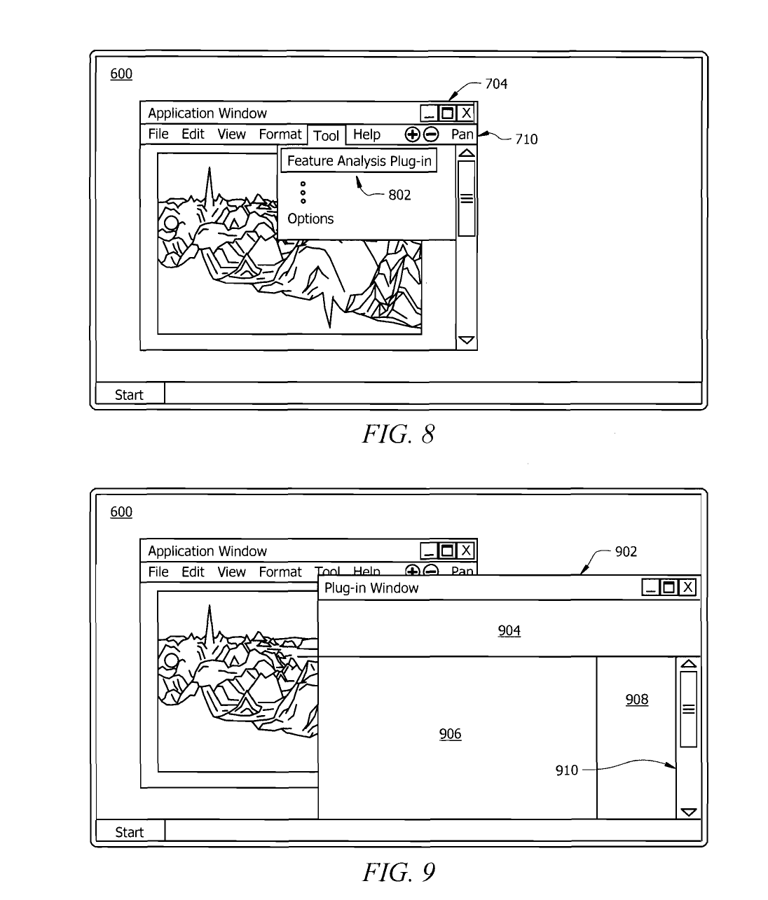

After the topographical model is presented to a user of the computing device (e.g., computing device 102 of FIG. 1), a feature analysis plug-in is launched, as shown by step 309. The feature analysis plug-in can be launched in response to a user-software interaction. For example, as shown in FIG. 8, a feature analysis plug-in is launched by selecting an item 802 of a drop down menu of a toolbar 710. Once the feature analysis plug-in is launched, step 310 is performed where a plug-in window is displayed on top of the desktop window and/or application window. A schematic illustration of an exemplary plug-in window 902 is provided in FIG. 9. As shown in FIG. 9, the plug-in window 902 comprises a toolbar 904, a display area 906, an attribute pane 908, and a scrollbar 910. A schematic illustration of the toolbar 904 is provided in FIG. 10A. As shown in FIG. 10A, the toolbar 904 comprises a plurality of exemplary GUI widgets 1002-1032. Each of the GUI widgets 1002-1032 is described above in detail.

Referring again to FIG. 3A, a next step 311 involves receiving a user input for selecting a first “item” contained in the first topographical model displayed in the application window. The “item” can include, but is not limited to, an SME, an obscuration, a void, a cultural feature, or foliage. In response to the user-software interaction of step 311, the feature analysis plug-in automatically and simultaneously generates a plurality of first model chips, as shown by step 312. The first model chips are generated using the data generated in previous step 304 and the data defining the first topographical model. The first model chips comprise panned and/or zoomed views of the first topographical model including content that was previously identified as the selected “item” and “items” of the same type as the selected “item”. Each of the model chips can include a single “item” or a cluster of “items”. Also, data defining the “items” of the first model chips can be color coded such that the “items” are visually distinguishable from other content thereof.

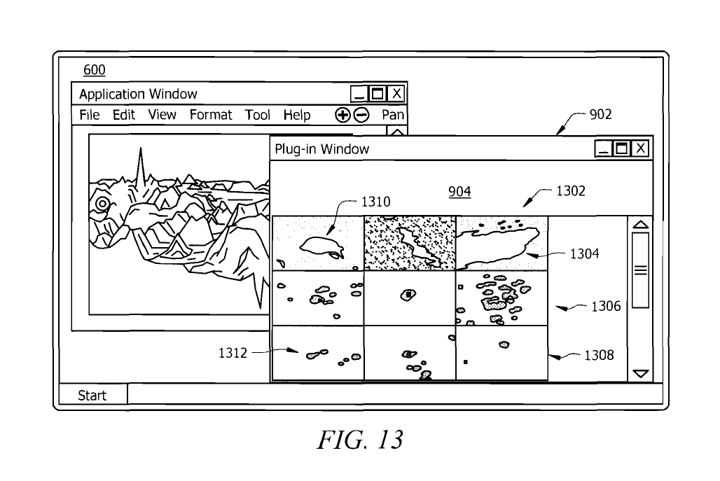

Upon completing step 312, step 313 is performed where at least one first screen page of first model chips is created by the feature analysis plug-in. The model chips are arranged on the first screen page in a grid or matrix format. The grid or matrix of the first model chips has a default size (e.g., ten cells by ten cells) or a user-specified size (e.g., three cells by three cells). In a next step 314, the first screen page of first model chips is displayed in a plug-in window. A schematic illustration of a displayed screen page of model chips 1302 is provided in FIG. 13. As shown in FIG. 13, the screen page 1302 comprises a grid 1306 defined by a plurality of grid cells 1308. A different model chip 1304 is presented within each grid cell 1308 of the grid 1306. Each model chip 1304 comprises a single void 1310 or a cluster of voids 1312. Embodiments of the present invention are not limited to the particularities of FIG. 13.

Subsequent to displaying the first screen page of first model chips in the plug-in window, the method 300 continues with step 315 of FIG. 3B. In step 315, the first model chips are analyzed by a user of the computing device (e.g., computing device 102 of FIG. 1). The first model chips are analyzed for purposes of determining which of the “items” (e.g., SMEs, obscurations, voids, and/or cultural features) previously identified in step 304 need to be repaired, filled or removed. During or subsequent to this analysis, steps 316-320 can be performed.

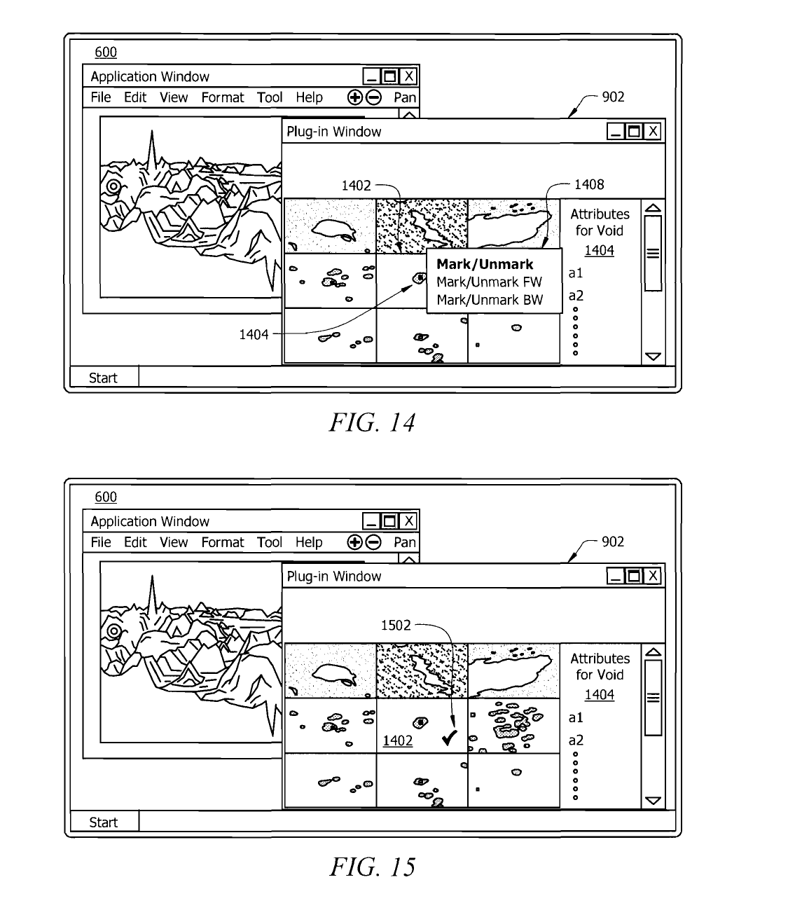

Step 316 involves receiving a user input selecting at least one of the first model chips by the computing device (e.g., computing device 102 of FIG. 1). The first model chip that is selected in step 316 comprises at least one item (e.g., an SME, obscuration, void, foliage or cultural feature) that needs to be repaired, filled or removed from the first topographical model. The model chip can be selected by moving a mouse cursor over the model chip and clicking a mouse button. A schematic illustration of a selected model chip 1402 is provided in FIG. 14. As shown in FIG. 14, the selected model chip 1402 is annotated with a relatively thick and distinctly colored border. Embodiments of the present invention are not limited in this regard. Any type of mark or annotation can be used to illustrate that a particular model chip has been selected.

In response to this user input, step 317 is performed where attribute information for the item(s) contained in the selected model chip is displayed in an attribute pane (e.g., attribute pane 908 of FIG. 9) of the plug-in window (e.g., plug-in window 902 of FIG. 9). A schematic illustration of an exemplary plug-in window 902 is provided in FIG. 14 which has attribute information a1, a2 for a void 1404 displayed therein.

Although not shown in FIG. 3B, the first topographical model displayed in the application window may also be updated in step 317 such that the contents of the selected model chip are displayed in the application window. In this regard, the application window can be updated to include a new panned and/or zoomed view of the first topographical model. In some embodiments of the present invention, the updated view of the first topographical model is: (a) a panned only view having the same zoom resolution as the original view; or (b) a panned and zoomed view having a zoom resolution that is different than that of the original view, wherein the zoom resolution of the updated view is a default zoom resolution or a user defined zoom resolution. Also, the updated view of the first topographical model may include the “item” (e.g., void 1404 of FIG. 14) at a pre-determined location therein, e.g., the center thereof. Embodiments of the present invention are not limited in this regard.

Referring again to FIG. 3B, the method 300 continues with step 318 where a user input is received by the computing device (e.g., computing device 102 of FIG. 1) for marking at least one model chip of the displayed first model chips. Step 318 can involve selecting a model chip. The model chip can be selected by moving a mouse cursor over the model chip and clicking a mouse button. In response to the click of the mouse button, a menu is presented to the user of the computing device. The menu includes a list of commands, such as a command for enabling “Mark/Unmark” operations, “Mark/Unmark FW” operations, and “Mark/Unmark BW” operations of the feature analysis plug-in. By enabling the “Mark/Unmark” operations, only the selected model chip will have a mark or annotation added thereto. By enabling the “Mark/Unmark FW” operations, the selected model chip and all model chips that precede the selected model chip in an order will have a mark or annotation added thereto. By enabling the “Mark/Unmark BW” operations, the selected model chip and all model chips that succeed the selected model chip in an order will have a mark or annotation added thereto.

Schematic illustrations of an exemplary selected model chip 1402 and an exemplary menu 1408 are provided in FIGS. 14, 16 and 18. As shown in FIGS. 14, 16 and 18, the selected model chip 1404 is annotated with a relatively thick and distinctly colored border. Also, a selected command “Mark/Unmark”, “Mark/Unmark FW” or “Mark/Unmark BW” of the menu 1408 is annotated by bolding the text thereof. Embodiments of the present invention are not limited in this regard. Any type of mark or annotation can be used to illustrate that a particular mode chip has been selected and/or that a particular command of a menu has been selected.

In response to the reception of the user input in step 318 of FIG. 3B, the feature analysis plug-in performs step 319. In step 319, at least the selected model chip is automatically marked with a pre-defined mark. Schematic illustrations of model chips 1402, 1702, 1704, 1706, 1708, 1902, 1904, 1906, 1908 marked with marks 1502 is provided in FIGS. 15, 17 and 19. Embodiments of the present invention are not limited to the particularities of FIGS. 15, 17 and 19. Any type of mark or annotation can be employed to illustrate that a model chip has been marked.

Referring again to FIG. 3B, the method 300 continues with step 320 where all of the “marked” model chips are exported to a table or file. The exportation can be initiated by a user of the computing device using a GUI widget (e.g., GUI widget 1016 or 1018 of FIG. 10A) of the plug-in window.

In a next step 321, a TM editing software application is launched. TM editing software applications are well known in the art, and therefore will not be described herein. Any such TM editing software application can be used with the present invention without limitation. However, it should be understood that the TM editing software application is configured to facilitate the repair of SMEs, the filling of voids, the removal of cultural features from a topographical model, and the removal of foliage from a topographical model. The TM editing software application can be launched in response to a user software interaction. For example, a TM editing software application can be launched by accessing and selecting an entry (not shown) on a start menu (e.g., start menu 602 of FIG. 6) of a desktop window (e.g., desktop window 600 of FIG. 6).

After the TM editing software application has been launched, a second topographical model is generated in step 322. Step 322 involves performing manual and/or automatic operations to edit the first topographical model. The edits can include, but are not limited to, repairing SMEs of the first topographical model, filling voids of the first topographical model, removing cultural features from the first topographical model, and/or removing foliage/vegetation from the first topographical model. The second topographical model is stored in a data store (e.g., data store 110 of FIG. 1), as shown by step 323.

In a next step 324, the computing device (e.g., computing device 102 of FIG. 1) receives a user input for viewing screen pages of model chips comprising content of the first topographical model including “items” of interest, and for viewing screen pages of model chips comprising the corresponding repaired “items” of the second topographical model. In response to this user input, the feature analysis automatically and simultaneously generates a plurality of second model chips using the data of the second topographical model, as shown by step 325. The second model chips comprise panned and/or zoomed views of the second topographical model including repaired, filled and/or removed “items”. The “items” can include, but are not limited to, repaired SMEs of a topographical model, repaired obscurations of the topographical model, filled voids of the topographical model, removed cultural features of the topographical model, and/or removed foliage/vegetation of the topographical model. Each of the second model chips includes a single “item” or a cluster of “items”.

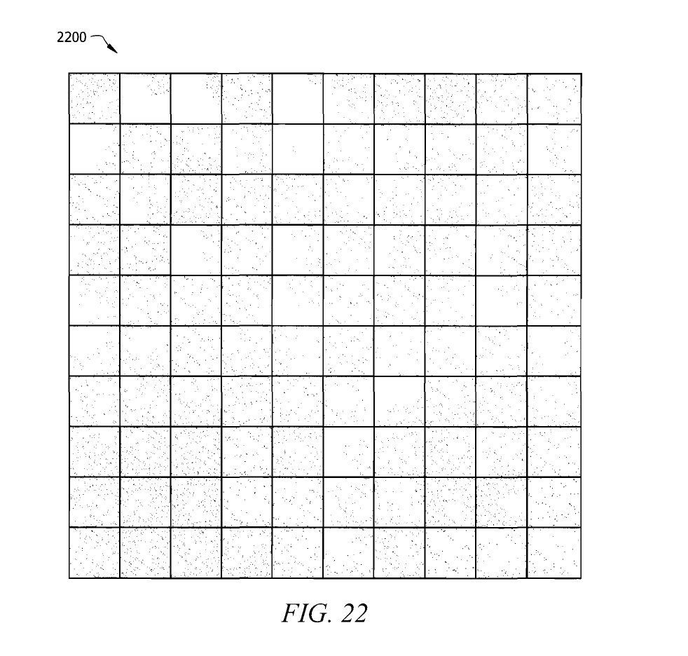

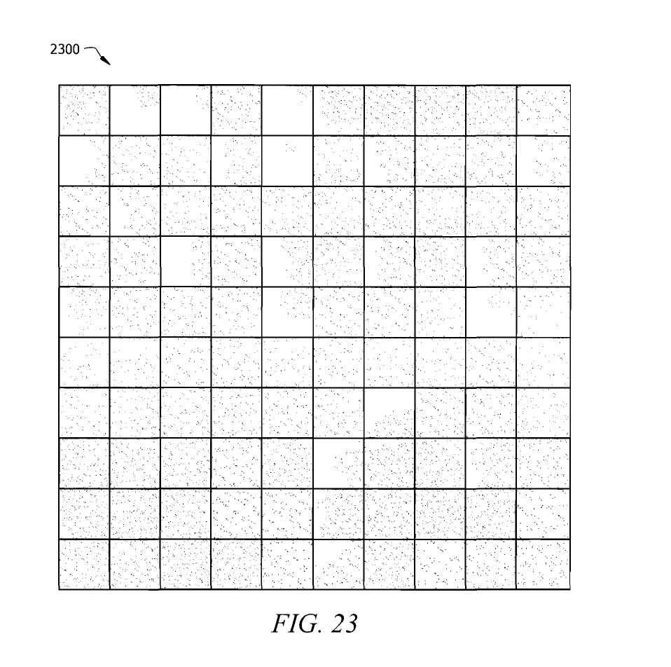

Upon completing step 325, the method 300 continues with step 326 of FIG. 3C. As shown in FIG. 3C, step 326 involves creating at least one screen page of second model chips. The screen page of second model chips is created by the feature analysis plug-in. The second model chips are arranged in the screen page in a grid or matrix format. The grid or matrix of the first model chips has a default size (e.g., ten cells by ten cells) or a user-specified size (e.g., three cells by three cells). Schematic illustrations of exemplary screen pages of second model chips are provided in FIGS. 21 and 23. As shown in FIG. 21, the model chips 2102-2150 of screen page 2100 each comprise a filled void. Similarly, as shown in FIG. 22, the model chips of screen page 2300 each comprise a filled void.

In a next step 327 of FIG. 3C, the feature analysis plug-in creates a second screen page of first model chips including content comprising the “items” which correspond to the repaired/filled/removed “items” of the second topographical model. In some embodiments, the first model chips include, but are not limited to, content comprising SMEs which correspond to the repaired SMEs/obscurations of the second topographical model, the voids which correspond to the filled voids of the second topographical model, cultural features which correspond to bare surface locations of the second topographical model where the cultural features were removed, and/or foliage/vegetation which correspond to bare surface locations of the second topographical model where the foliage/vegetation was removed.

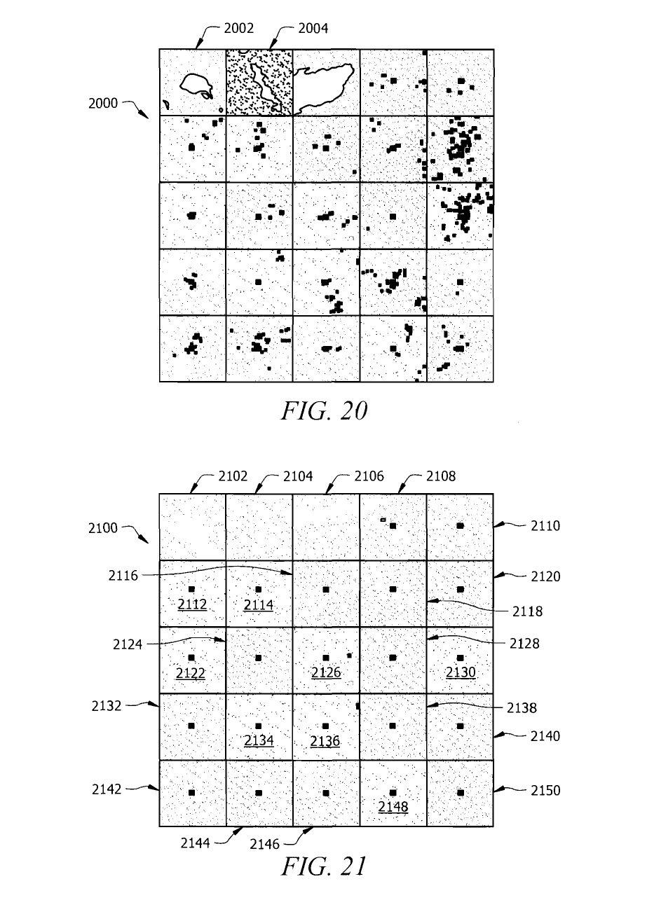

Schematic illustrations of exemplary second screen pages of first model chips are provided in FIGS. 20 and 22. As shown in FIG. 20, the model chips of the screen page 2000 comprise unfilled voids. The unfilled voids of screen page 2000 correspond to the filled voids of screen page 2100 of FIG. 21. For example, the void of model chip 2002 of FIG. 20 corresponds to the filled void of model chip 2102 of FIG. 21. Similarly, the void of model chip 2004 of FIG. 20 corresponds to the filled void of model chip 2104 of FIG. 21, and so on. As similarly shown in FIG. 22, the model chips of the screen page 2200 comprise unfilled voids which correspond to the filled voids of screen page 2300. Although the unfilled voids are shown as black patches in FIG. 20 and white patches in FIG. 22, embodiments of the present invention are not limited in this regard. Any type of coloration or other indicator can be used to schematically illustrate an unfilled void.

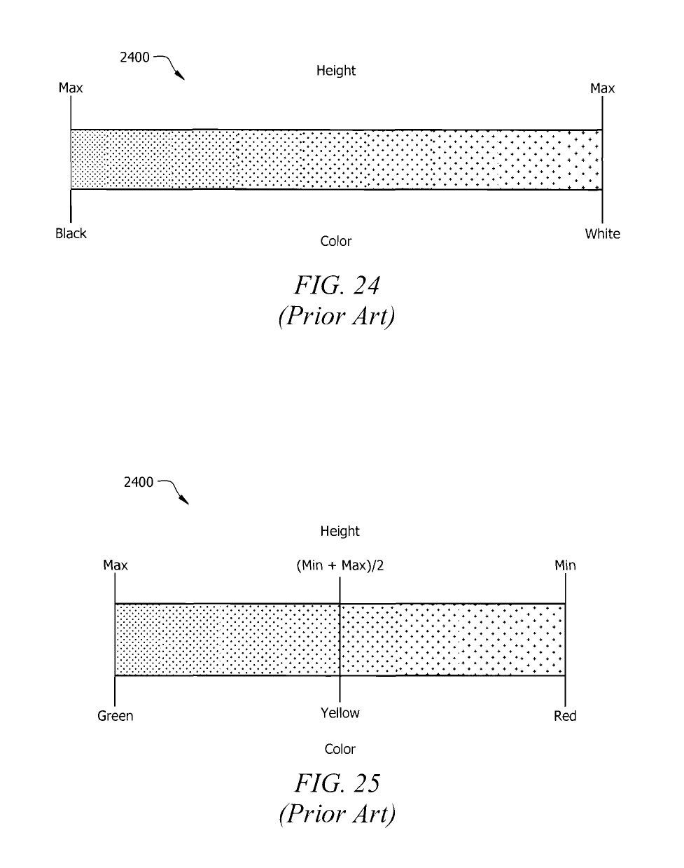

Referring again to FIG. 3C, the method 300 continues with step 328 where the second screen page of first model chips is displayed in the plug-in window (e.g., plug-in window 704 of FIG. 7). In a next step 329, the computing device (e.g., computing device 102 of FIG. 1) receives a user input for setting a mode of at least one first model chip and/or at least one second model chip to a color scale mode or a grey scale mode. In the color scale mode, the terrain elevation data is color coded in accordance with a color ramp of a color scale. A schematic illustration of an exemplary color ramp 2500 of a color scale is provided in FIG. 25. In grey scale mode, the terrain elevation data is color coded in accordance with a color ramp of a grey scale. A schematic illustration of an exemplary color ramp 2400 of a grey scale is provided in FIG. 24. The mode of a model chip can be set using a GUI widget of a toolbar (e.g., toolbar 710 of FIG. 7) of the plug-in window (e.g., plug-in window 704 of FIG. 7), and/or by selecting a command from a menu of commands accessed via a mouse click of the model chip.

After completing step 329, the method 300 continues with step 330 where the computing device (e.g., computing device 102 of FIG. 1) receives a user input for toggling between the second screen page of first model chips and the screen page of second model chips. The user input is facilitated by a GUI widget (e.g., GUI widget 1024 of FIG. 10A) of the plug-in window. The GUI widget is configured to allow manual cycling and/or automatic cycling between screen pages for a plurality of topographical models. As such, the GUI widget may include, but is not limited to, a check box for enabling and disabling automatic topographical model cycling operations of the feature analysis plug-in, a slider for setting the rate at which the topographical models automatically cycle, and/or a button for manually commanding when to change the topographical model. In response to this user input of step 330, the content of the plug-in window is alternated between the second screen page of first model chips and the screen page of second model chips, as shown by step 331.

In a next step 332, the computing device (e.g., computing device 102 of FIG. 1) receives a user input for sorting or filtering at least the second model chips based on at least one attribute of “items” thereof. The “items” can include, but are not limited to, repaired SMEs, repaired obscurations, filled voids, removed cultural features, removed foliage/vegetation, and/or bare surfaces. The attribute can include, but is not limited to, a void size, a void fill accuracy, an SME repair accuracy, an obscuration repair accuracy, prediction error, a maximum height statistical value, a minimum height statistical value, and void characteristics. The user input is facilitated by a GUI widget (e.g., GUI widget 1014 or GUI widget 1012 of FIG. 10A) of the plug-in window (e.g., the plug-in window 702 of FIG. 7). The GUI widget may be configured to allow a user to specify the attribute(s) that the sorting or filtering should be based on. The GUI widget may also be configured to allow a user to specify whether the model chips should be sorted in an ascending order or a descending order.

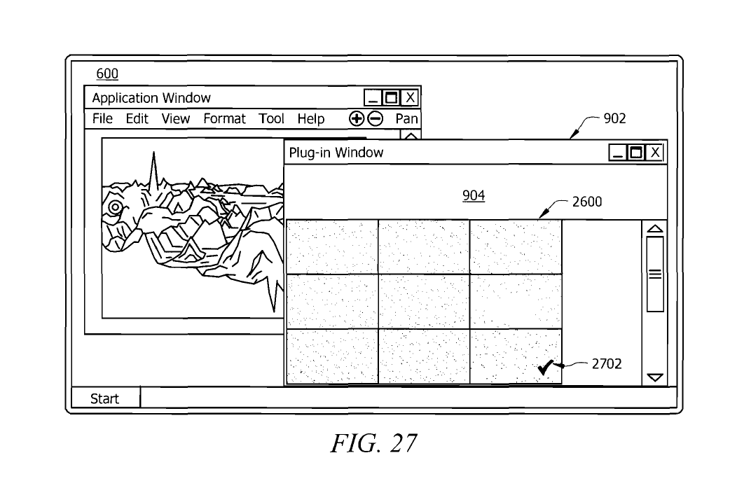

In response to the user input of step 332, the feature analysis plug-in performs operations for sorting or filtering the second model chips based on at least one user-selected attribute, as shown by step 333. Thereafter in step 334, at least one screen page of sorted/filtered model chips is created by the feature analysis plug-in. The sorted/filtered model chips are arranged on the screen page in a pre-defined grid format or a matrix format. The screen page of sorted/filtered model chips is then displayed in the plug-in window, as shown by step 335. A schematic illustration of an exemplary screen page of sorted model chips 2600 displayed in a plug-in window 902 is provided in FIG. 27.

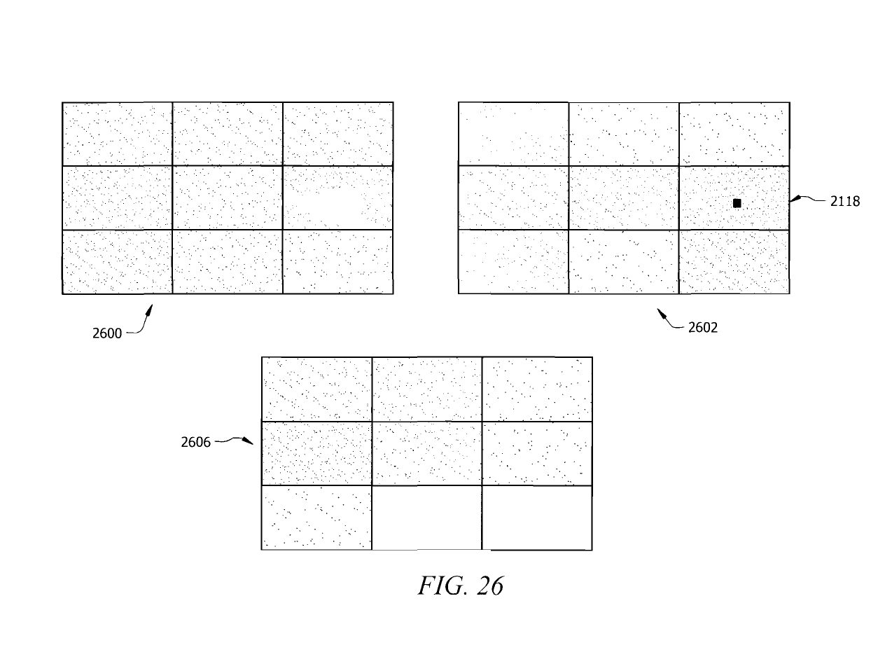

Notably, a screen page of sorted model chips may or may not include the same views as the screen page from which it is derived. For example, if the first grid has a grid size of five cells by five cells as shown in FIG. 21, then views one through twenty five are presented therein. These twenty five views are referred to in FIG. 21 by reference numbers 2102-2150. Thereafter, an ordered list is generated by sorting the twenty five panned and/or zoomed views by at least one attribute (e.g., void fill accuracy). Also, a new grid size of three cells by three cells is selected. In this scenario, three screen pages of sorted model chips 2600, 2602, 2606 of FIG. 26 are created by the feature analysis plug-in. Each of the screen pages 2600, 2602, 2606 includes nine views identified in the ordered list. These nine views of the ordered list may include select ones of the original unsorted views 2102-2150. Notably, two cells of screen page 2606 are absent of model chips. This is due to the fact that there are less model chips then there are cells of the three screen pages 2600, 2602, 2606. Embodiments of the present invention are not limited to the particularities of FIGS. 21 and 26.

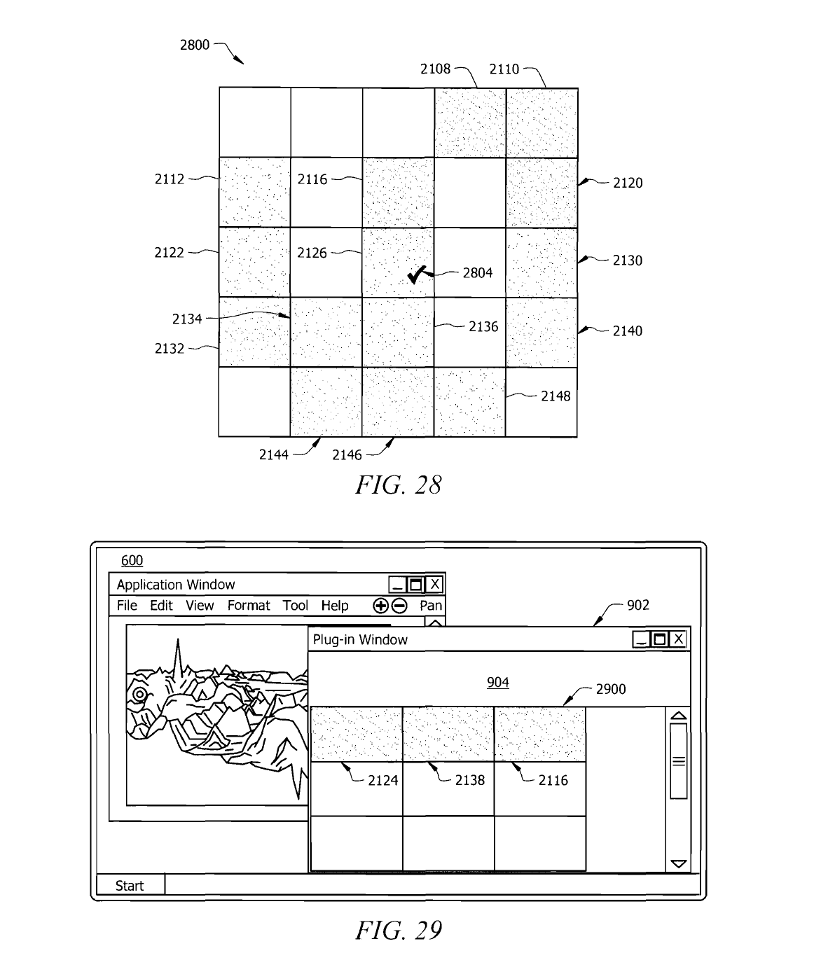

A screen page of filtered model chips is created by removing at least one model chip from the displayed screen page of second model chips in accordance with the results of the filtering operations performed in previous step 333. A schematic illustration of an exemplary screen page of filtered model chips 2800 is provided in FIG. 28. As shown in FIG. 28, the screen page of filtered model chips 2800 includes the model chips 2108-2112, 2116, 2120, 2122, 2126, 2130-2136, 2140, 2144-2148 contained in the screen page of model chips 2100 of FIG. 21. However, the screen page of filtered model chips 2800 does not include model chips 2102-2106, 2114, 2118, 2124, 2128, 2138, 2142, 2150 in grid cells thereof. In this regard, it should be understood that model chips 2102-2106, 2114, 2118, 2124, 2128, 2138, 2142, 2150 have been removed from the screen page of model chips 2100 of FIG. 21 to obtain the screen page of filtered model chips 2800. Embodiments of the present invention are not limited in this regard.

Referring again to FIG. 3C, the method 300 continues with an optional step 336 of FIG. 3D upon the completion of step 335. As shown in FIG. 3D, step 336 involves optionally marking at least one of the sorted/filtered model chips in accordance with a user-software interaction to indicate that an “item” thereof was repaired, filled or removed unsatisfactorily. For example, the mark can indicate that: an SME/obscuration repair was unsatisfactory; a void fill was unsatisfactory; a cultural feature removal was unsatisfactory; or a foliage/vegetation removal was unsatisfactory. Schematic illustrations of exemplary sorted/filtered model chips 2126 with marks 2702, 2804 added thereto are provided in FIGS. 27-28.

In a next step 337, the computer device (e.g., computing device 102 of FIG. 1) receives a user input for viewing only a portion (e.g., a percentage) of the second model chips generated in previous step 325. The user input is facilitated by a GUI widget (e.g., GUI widget 1020 of FIG. 10A) of the plug-in window (e.g., the plug-in window 902 of FIG. 9). The GUI widget is configured to facilitate the display of a random sample of model chips of “items” of a particular content class for visual inspection. As such, the GUI widget may include, but is not limited to, a button for enabling/disabling a random sampling function of the feature analysis plug-in and a drop down menu from which a percentage value can be selected.

In response to the reception of the user input in step 337, step 338 is performed where “N” model chips of the second model chips generated in previous step 325 are randomly selected. The value of “N” is determined based on the percentage value selected in previous step 337. For example, if one hundred second model chips were generated in step 325 and the percentage value of twenty was selected in step 337, then twenty model chips would be randomly selected from the one hundred second model chips. Embodiments of the present invention are not limited in this regard.

Upon completing step 338, step 339 is performed where the feature analysis plug-in creates at least one screen page of sampled model chips including all or a portion of the “N” model chips arranged in a grid or matrix format. In step 340, the screen page of sampled model chips is displayed in the plug-in window. Notably, the screen pages of sampled model chips can have a default grid size or a user-specified grid size. For example, if a grid size is four cells by four cells and “N” equals twenty, then two screen pages of sampled model chips would be created in step 339 since each screen page can contain a maximum of sixteen model chips. In contrast, if the grid size is five cells by five cells and “N” equals twenty, then only one screen page of sampled model chips would be created in step 339 since the screen page can contain a maximum of twenty-five model chips. Embodiments of the present invention are not limited in this regard.

A schematic illustration of an exemplary screen page of sampled model chips 2900 is provided in FIG. 29. As shown in FIG. 29, the screen page of sampled model chips 2900 includes only three model chips 2124, 2138, 2116. In this regard, the total number of second model chips is twenty five and the percentage selected in step 337 is twelve percent. Accordingly, the value of “N” is three. The three model chips contained in the screen page 2900 were randomly selected from the twenty five second model chips 2102-2150 of FIG. 21. Embodiments of the present invention are not limited to the particularities of this example.

Referring again to FIG. 3D, the method 300 continues with step 341 where the computing device (e.g., computing device 102 of FIG. 1) receives a user input for viewing “items” (e.g., SMEs, obscurations, voids, cultural features, and/or foliage/vegetation) of the first model chips at a user-specified zoom level of scale. The user input is facilitated by a GUI widget (e.g., GUI widget 1026 of FIG. 10A) of the plug-in window (e.g., plug-in window 902 of FIG. 9). The GUI widget is configured to facilitate the performance of manual-scale operations by the feature analysis plug-in. The manual-scale operations are operative to adjust the zoom level of scale of all of the displayed model chips from a first zoom level of scale to a second zoom level of scale in response to a user-software interaction. The first zoom level of scale is a default zoom level of scale (e.g., 100%) or a previously user-selected zoom level of scale (e.g., 50%). The second zoom level of scale is a new user-selected zoom level of scale (e.g., 75%). As such, the GUI widget may include, but is not limited to, a drop down list populated with a plurality of whole number percentage values.

After the reception of the user input in step 341, the feature analysis plug-in performs operations for automatically and concurrently generating a plurality of “fixed zoomed” model chips comprising “items” (e.g., SMEs, obscurations, voids, cultural features, and/or foliage/vegetation) at the user-specified zoom level of scale, as shown by step 342. In a next step 343, the feature analysis plug-in performs operations to create a screen page of “fixed zoomed” model chips. Thereafter in step 344, the screen page of “fixed zoomed” model chips is displayed in the plug-in window.

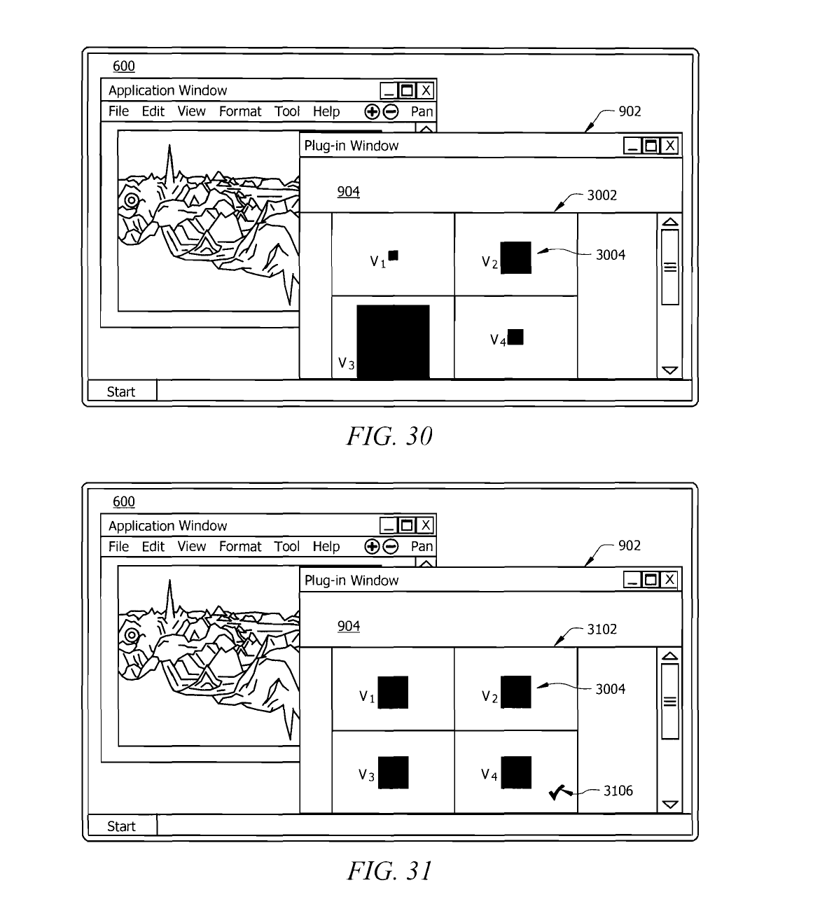

A schematic illustration of an exemplary screen page of “fixed zoomed” model chips 3002 is provided in FIG. 30. As shown in FIG. 30, all of the model chips 3004 have the same zoom level of scale. As such, the smallest item V₁ (e.g., a first void) appears smaller than the larger items V₂, V₃, V₄ (e.g., a second, third and fourth void). Similarly, the largest item V₃ (e.g., a third void) appears larger than the smaller items V₁, V₂, V₄ (e.g., a first, second and fourth void). Embodiments of the present invention are not limited to the particularities of FIG. 30.

Referring again to FIG. 3D, the method 300 continues with step 345. In step 345, the computing device (e.g., computing device 102 of FIG. 1) receives a user input for viewing the items of the first model chips (e.g., SMEs, obscurations, voids, cultural features, and/or foliage/vegetation) at a best-fit zoom level of scale. The user input is facilitated by a GUI widget (e.g., GUI widget 1028 of FIG. 10A) of the plug-in window (e.g., plug-in window 902 of FIG. 9). The GUI widget is configured to facilitate the viewing of each displayed item at its best-fit zoom level of scale or its pre-defined maximum zoom level of scale. As such, the GUI widget may include, but is not limited to, a button for at least enabling auto-scale operations of the feature analysis plug-in and disabling the manual-scale operations of the feature analysis plug-in.

In response to the reception of the user input in step 345, the feature analysis plug-in performs operations to automatically and concurrently generate a plurality of “auto zoomed” model chips comprising the currently displayed items at the best-fit zoom level of scale, as shown by step 346 of FIG. 3D. In a next step 347 of FIG. 3E, the feature analysis plug-in performs operations to create a screen page of “auto zoomed” model chips. Thereafter in step 348, the screen page of “auto zoomed” model chips is displayed in the plug-in window.

A schematic illustration of an exemplary screen page of “auto zoomed” model chips 3102 is provided in FIG. 31. As shown in FIG. 31, each of the model chips 3104 has a different zoom level of scale. As such, all of the “items” V₁, V₂, V₃, V₄ (e.g., a first, second, third and fourth void) appear to be of the same size regardless of their actual relative physical sizes. Embodiments of the present invention are not limited to the particularities of FIG. 31.

Referring again to FIG. 3E, the method 300 continues with step 349. In step 349, the computing device (e.g., computing device 102 of FIG. 1) receives a user input for adjusting a contrast of at least one of the “auto zoomed” model chips using a histogram thereof. The user input can be facilitated by a GUI widget (e.g., GUI widget 1022) of the plug-in window. The GUI widget facilitates the toggling of histogram stretch of model chips on and off. Histogram stretch leads to brighter and higher-contrast imagery. Accordingly, histogram stretch is achieved by adjusting the global contrasts of model chips or topographical models using histograms thereof. As such, the GUI widget includes, but is not limited to, a button for enabling and disabling a histogram stretch function of the feature analysis plug-in. Histogram stretch is well known in the art, and therefore will not be described herein. Still, it should be understood that histogram stretch can be turned on and off for terrain elevation data and/or for imagery.

In response to the user input of step 349, the feature analysis plug-in performs operations to adjust the contrast of the “auto zoomed” model chip(s). In a next optional step 351, the feature analysis plug-in performs operations for marking at least one of the “auto zoomed” model chips in accordance with a user-software interaction to indicate that the “item” repair/fill/removal thereof is unsatisfactory. A schematic illustration of an exemplary “auto zoomed” model chip 3104 with a mark 3106 added thereto is provided in FIG. 31.

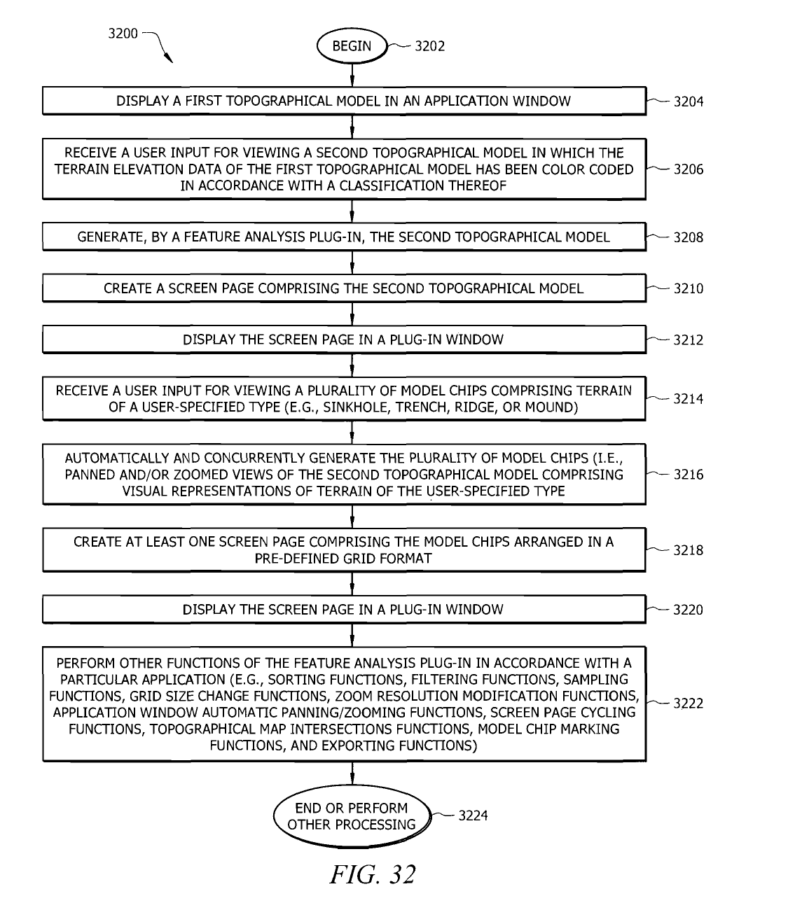

Upon completing step 351, step 352 is performed. Step 352 involves generating a third topographical model by satisfactorily repairing/filling/removing the “item” of the marked model chips of the second topographical model. In some scenarios, step 352 can involve satisfactorily repairing the SMEs/obscurations of marked model chips of the second topographical model, satisfactorily filling the voids of marked model chips of the second topographical model, and/or satisfactorily removing cultural features and/or foliage/vegetation so as to accurately show the bare surface thereunder. Subsequent to the generation of the third topographical model, step 353 is performed where the method 300 ends or other processing is performed. Example of the “other processing” that can be performed in step 353 will be described below in relation to FIGS. 32-35.

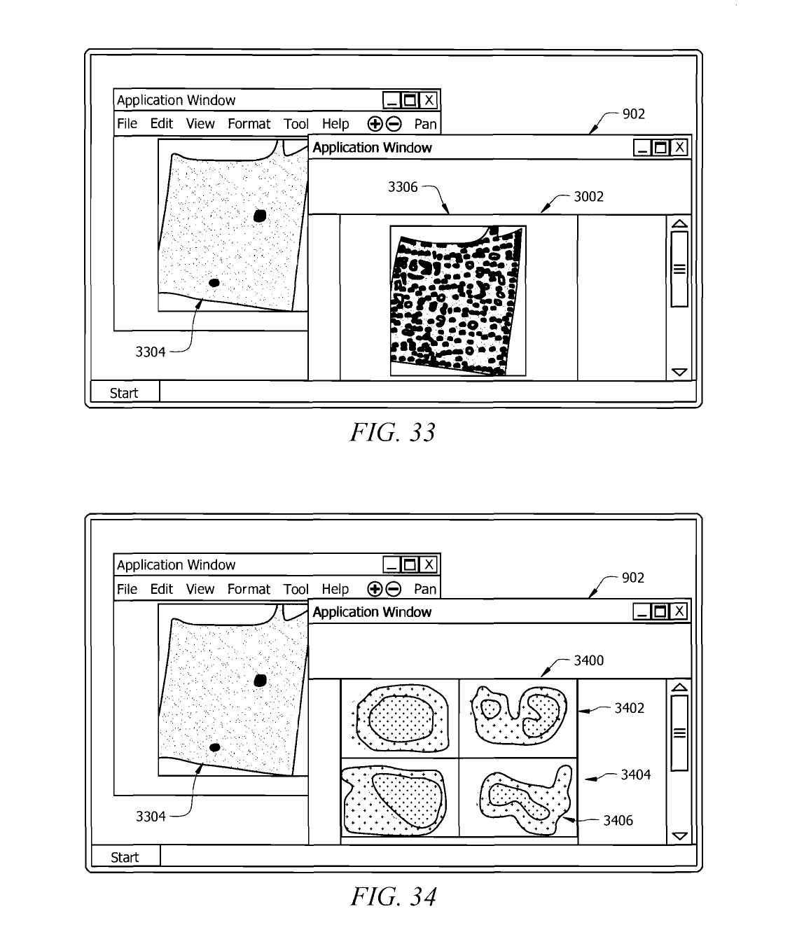

Referring now to FIG. 32, there is provided a flow diagram of an exemplary method 3200 for efficiently analyzing different types of terrain of a topographical model. As shown in FIG. 32, the method 3200 begins with step 3202 and continues with step 3204 where a first topographical model (e.g., topographical model 3304 of FIG. 33) is displayed in an application window (e.g., application window 704 of FIG. 33) of a computing device (e.g., computing device 102 of FIG. 1). In a next step 3206, a computing device receives a user input for viewing a second topographical model in which the terrain data of the first topographical model has been color coded in accordance with a classification thereof. The user input can be facilitated by a GUI widget (e.g., GUI widget 1030 of FIG. 10A). The GUI widget is provided to facilitate the classification of terrain of a first topographical model (e.g., topographical model 3304 of FIG. 33) and the generation of a second topographical model (e.g., topographical model 3306 of FIG. 33) clearly distinguishing the different types of terrain visually represented in the first topographical model. The types of terrain can be distinguished by color coding terrain elevation data of the first topographical map in accordance with a defined color scheme. Methods for color coding terrain elevation data are well known in the art, and therefore will not be described herein. However, it should be understood that any known method for color coding terrain elevation data can be used with the present invention without limitation. The GUI widget can include, but is not limited to, a button for enabling and disabling terrain classification functions of the feature analysis plug-in.

In response to the user input of step 3206, the feature analysis plug-in generates the second topographical model, as shown by step 3208. In a next step 3210, the feature analysis plug-in creates a screen page comprising the second topographical model. This screen page is then displayed in a plug-in window of the computing device, as shown by step 3212. A schematic illustration of an exemplary screen page 3302 comprising an exemplary color coded topographical model 3306 is provided in FIG. 33.

As shown in FIG. 32, the method 3200 continues with step 3214. In step 3214, the computing device receives a user input for viewing a plurality of model chips comprising terrain of a user-specified type (e.g., a sinkhole, a trench, a ridge or a mound). In response to this user input, the feature analysis plug-in automatically and concurrently generates a plurality of model chips, as shown by step 3216. The model chips comprise panned and/or zoomed views of the second topographical model comprising visual representations of terrain of the user-specified type. Thereafter, the feature analysis plug-in creates at least one screen page comprising the model chips arranged in a pre-defined grid format, as shown by step 3218. The screen page is then displayed in the plug-in window of the computing device, as shown by step 3220. A schematic illustration of an exemplary screen page 3302 is provided in FIG. 34. As shown in FIG. 34, the screen page 3302 comprises a grid 3404 defined by a plurality of grid cells 3406. Each of the grid cells 3406 has a model chip 3402 presented therein.

Referring again to FIG. 32, the method 3200 continues with step 3222 where other functions of the feature analysis plug-in are performed in accordance with a particular application. In this regard, step 3222 can involve performing one or more of the following: sorting functions for sorting model chips based on at least one attribute of the content thereof; filtering functions for filtering model chips based on at least one attribute of the content thereof; sampling functions for presenting a random sample of a plurality of model chips in a plug-in window; grid size change functions for changing a grid size of a grid; zoom resolution modification functions for changing a zoom resolution of one or more model chips; application window automatic panning/zooming functions for automatically panning and/or zooming a view of a topographical model displayed in an application window such that the contents of a selected model chip of a plug-in window is presented in the application window; screen page cycling operations for cycling through screen pages for a plurality of topographical models; topographical model intersection functions for filtering items, features, terrain, and/or foliage/vegetation which lie outside of an area (e.g., a geographical area) defined either by the area that a plurality of topographical models have in common or by the area covered by a plurality of topographical models taken together; marking functions for marking one or more model chips with a mark or annotation; and exporting functions for exporting marked model chips to a table or file. Subsequently, step 3224 is performed where the method 3200 ends or other processing is performed.

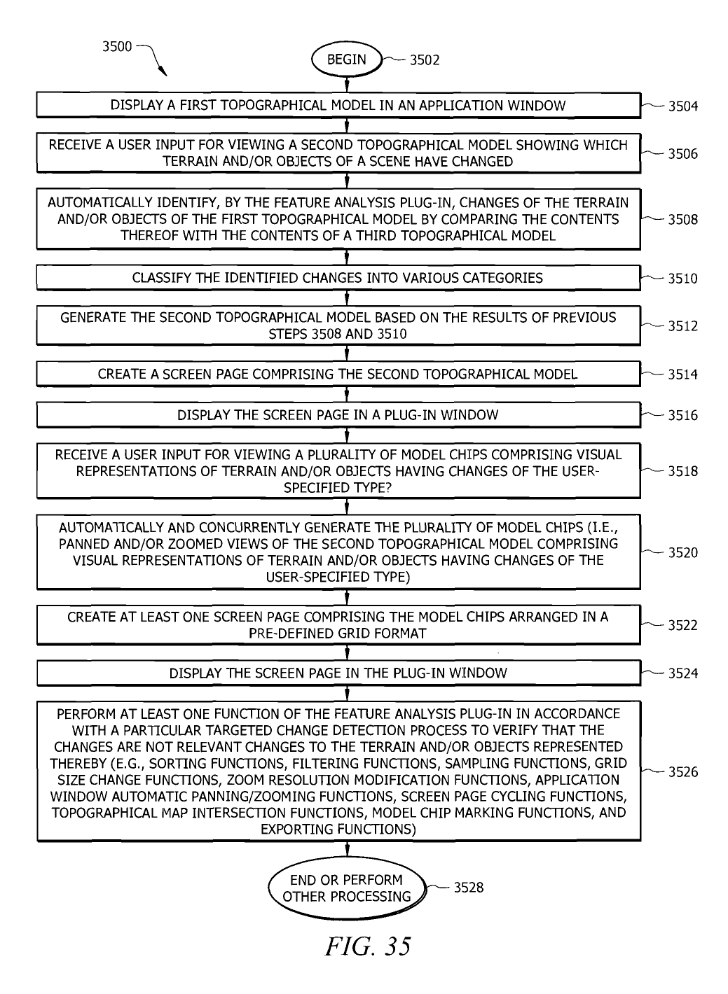

Referring now to FIG. 35, there is provided a flow diagram of an exemplary method 3500 for efficient terrain and feature data change detection. As shown in FIG. 35, the method 3500 begins with step 3504 and continues with step 3506 where a first topographical model is displayed in an application window (e.g., application window 704 of FIG. 7) of a computing device (e.g., computing device 102 of FIG. 1). In a next step 3506, the computing device receives a user input for viewing a second topographical model showing which terrain and/or objects of a scene have changed. In response to this user input, the feature analysis plug-in performs steps 3508-3512 for generating the second topographical model. Methods for generating a topographical model including difference indication indicating a change of a scene's content are well known in the art. Any such method can be used with the present invention without limitation. One such method is described in U.S. Pat. No. 7,391,899 to Rahmes et al. This method generally involves the operations of steps 3508-3512.

Step 3508 involves automatically identifying changes of the terrain and/or objects of the first topographical model by comparing the contents thereof with the contents of a third topographical model. Thereafter, in step 3510, the identified changes are classified into various categories. Such categories include, but are not limited to: a positive elevation change category or a new content category including objects that are new to a scene; negative elevation change category or a deleted content category including objects that are removed from a scene; and a modified size category or a matched content category including objects whose size has increased or decreased. In a next step 3512, the second topographical model is generated based on the results of steps 3508 and 3510. The second topographical model includes different indications indicating changes of a scene's content. In some embodiments, the second topographical model shows changes to a scene in a topographical model as being a different color from parts of the scene that have not changed. For example, positive elevation changes are shown in green. Negative elevation changes are shown in red. Changes in object's sizes are shown in yellow. Embodiments of the present invention are not limited in this regard.

After the second topographical model has been generated, step 3514 is performed where the feature analysis plug-in creates a screen page comprising the second topographical model. This screen page is then displayed in a plug-in window (e.g., plug-in window 902 of FIG. 9), as shown by step 3516. Upon completing step 3516, the method 3500 continues with step 3518.

In step 3518, the computing device receives a user input for viewing a plurality of model chips comprising visual representations of terrain and/or objects having changes of a user-specified type. In response to this user input, the feature analysis plug-in automatically and concurrently generates a plurality of model chips, as shown by step 3520. The model chips comprise panned and/or zoomed views of the second topographical model comprising visual representations of terrain and/or objects having changes of the user-specified type. Next, in step 3522, the feature analysis plug-in creates at least one screen page comprising the model chips arranged in a pre-defined grid format. Thereafter, the screen page is displayed in the plug-in window, as shown by step 3524.

Upon completing step 3524, the method 3500 continues with step 3526 where other functions of the feature analysis plug-in are performed in accordance with a particular targeted change detection process to verify that the changes are not relevant changes to the terrain and/or objects represented thereby. In this regard, step 3526 can involve performing one or more of the following: sorting functions for sorting model chips based on at least one attribute of the content thereof; filtering functions for filtering model chips based on at least one attribute of the content thereof; sampling functions for presenting a random sample of a plurality of model chips in a plug-in window; grid size change functions for changing a grid size of a grid; zoom resolution modification functions for changing a zoom resolution of one or more model chips; application window automatic panning/zooming functions for automatically panning and/or zooming a view of a topographical model displayed in an application window such that the contents of a selected model chip of a plug-in window is presented in the application window; screen page cycling operations for cycling through screen pages for a plurality of topographical models; topographical model intersection functions for filtering items, features, terrain, and/or foliage/vegetation which lie outside of an area (e.g., a geographical area) defined either by the area that a plurality of topographical models have in common or by the area covered by a plurality of topographical models taken together; marking functions for marking one or more model chips with a mark or annotation; and exporting functions for exporting marked model chips to a table or file. Subsequently, step 3528 is performed where the method 3500 ends or other processing is performed.

Although the screen pages have been described above as comprising model chips generated using terrain elevation data defining a single topographical model, embodiments of the present invention are not limited in this regard. For example, a screen page can comprise an array defined by a plurality of cells. Each cell has a model chip presented therein. The model chips can comprise panned views, zoomed views, and/or panned-and-zoomed views of one or more topographical models. For example, a first model chip comprises a panned view, a zoomed view, or a panned-and-zoomed view of a first topographical model. A second model chip comprises a panned view, a zoomed view, or a panned-and-zoomed view of a second topographical model which is different than the first topographical model.

Also, in some embodiments, at least two model chips include at least one item that is the same. For example, a first model chip comprises a cluster of items (e.g., cultural features). A second model chip comprises one of the items of the cluster and/or content reflecting a repaired one of the items, a filled one of the items, or a removed one of the items. In this scenario, the first and second model chips can be highlighted when the first model chip is selected. Additionally, the intensities of all other model chips can be subdued.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for analyzing topographical models, comprising:
receiving, by a computing device, a user input selecting a first content type from a plurality of content types;
in response to the reception of said user input, simultaneously generating a plurality of first model chips using terrain elevation data defining a first topographical model, each of said first model chips comprising at least one of a panned-only view, a zoomed-only view, and a panned-and-zoomed view of said first topographical model including at least one item of said first content type that is different from all other items of all other first model chips; and
displaying, by said computing device, a first screen page comprising a first array defined by a plurality of first cells, each having one of said plurality of first model chips presented therein.

2. The method according to claim 1, wherein said plurality of content types comprise a surface model error, an obscuration, a void, a cultural feature, and foliage.

3. The method according to claim 1, wherein data defining said items of said first topographical model is color coded such that said items are visually distinguishable from other content of said first topographical model.

4. The method according to claim 1, wherein data defining said items of said first model chips is color coded such that said items are visually distinguishable from other content thereof.

5. The method according to claim 1, further comprising adding a mark or annotation to at least one chip of said plurality of first model chips indicating that said chip comprises an item that needs to be repaired, filled, or removed from said first topographical model.

6. The method according to claim 5, further comprising exporting at least said chip to a file or a table.

7. The method according to claim 1, further comprising:
simultaneously generating, by said computing device, a plurality of second model chips using terrain elevation data defining a second topographical model, each of said second model chips comprising at least one of a panned-only view, a zoomed-only view, and a panned-and-zoomed view of said second topographical model including content representing a repaired item of said first topographical model, a filled item of said first topographical model, or an item that has been removed from said first topographical model; and
displaying, by said computing device, a second screen page comprising a second array defined by a plurality of second cells, each having one of said plurality of second model chips presented therein.

8. The method according to claim 7, further comprising alternating content of a GUI window between said first screen page and said second screen page.

9. The method according to claim 1, further comprising setting a mode of at least one of said plurality of first model chips to a color scale mode or a grey scale mode.

10. The method according to claim 1, further comprising sorting or filtering said plurality of first model chips based on at least one attribute of said items thereof.

11. The method according to claim 10, wherein said attribute comprises surface model error characteristics, obscuration characteristics, accuracy metrics, void sizes, prediction errors, maximum height statistical values, minimum height statistical values, void characteristics, foliage characteristics, vegetation characteristics, terrain characteristics, scene change characteristics, or information describing attributes of an object which a cultural feature visually represents.

12. The method according to claim 1, further comprising randomly selecting and displaying a specified amount of said plurality of first model chips.

13. The method according to claim 1, further comprising changing a zoom level of scale of at least one of said first model chips.

14. The method according to claim 1, further comprising adjusting a contrast of at least one of said first model chips using a histogram thereof.

15. The method according to claim 1, further comprising color coding said terrain elevation data of said first topographical model in accordance with a classification of terrain thereof.

16. The method according to claim 15, wherein said plurality of content types comprises a sinkholes, trenches, hyperbolic terrain, planar terrain, ridges, and mounds.

17. The method according to claim 1, wherein said first topographical model comprises at least one difference indication indicating a change of a scene's content.

18. The method according to claim 17, wherein said plurality of content types comprises objects that are new to a scene, objects that are removed from a scene, objects whose size has increased or decreased.

19. A system, comprising:
at least one computing device configured to:
receive a user input selecting a first content type from a plurality of content types;
simultaneously generate a plurality of first model chips in response to said user input, said plurality of first model chips generated using terrain elevation data defining a first topographical model, each of said first model chips comprising at least one of a panned-only view, a zoomed-only view, and a panned-and-zoomed view of said first topographical model including at least one item of said first content type that is different from all other items of all other first model chips; and
display a first screen page comprising a first array defined by a plurality of first cells, each having one of said plurality of first model chips presented therein.

20. The system according to claim 19, wherein said plurality of content types comprise a surface model error, an obscuration, a void, a cultural feature, and foliage.

21. The system according to claim 19, wherein data defining said items of said first topographical model is color coded such that said items are visually distinguishable from other content of said first topographical model.

22. The system according to claim 19, wherein data defining said items of said first model chips is color coded such that said items are visually distinguishable from other content thereof.

23. The system according to claim 19, wherein said computing device is further configured to add a mark or annotation to at least one chip of said plurality of first model chips indicating that said chip comprises an item that needs to be repaired, filled, or removed from said first topographical model.

24. The system according to claim 23, wherein said computing device is further configured to export at least said chip to a file or a table.

25. The system according to claim 19, wherein said computing device is further configured to:
simultaneously generate a plurality of second model chips using terrain elevation data defining a second topographical model, each of said second model chips comprising at least one of a panned-only view, a zoomed-only view, and a panned-and-zoomed view of said second topographical model including content representing a repaired item of said first topographical model, a filled item of said first topographical model, or an item that has been removed from said first topographical model; and
display a second screen page comprising a second array defined by a plurality of second cells, each having one of said plurality of second model chips presented therein.

26. The system according to claim 25, wherein said computing device is further configured to alternate content of a GUI window between said first screen page and said second screen page.

27. The system according to claim 19, wherein said computing device is further configured to set a mode of at least one of said plurality of first model chips to a color scale mode or a grey scale mode.

28. The system according to claim 19, wherein said computing device is further configured to sort or filter said plurality of first model chips based on at least one attribute of said items thereof.

29. The system according to claim 28, wherein said attribute comprises surface model error characteristics, obscuration characteristics, accuracy metrics, void sizes, prediction errors, maximum height statistical values, minimum height statistical values, void characteristics, foliage characteristics, vegetation characteristics, terrain characteristics, scene change characteristics, or information describing attributes of an object which a cultural feature visually represents.

30. The system according to claim 19, wherein said computing device is further configured to randomly select and displaying a specified amount of said plurality of first model chips.

31. The system according to claim 19, wherein said computing device is further configured to change a zoom level of scale of at least one of said first model chips.

32. The system according to claim 19, wherein said computing device is further configured to adjust a contrast of at least one of said first model chips using a histogram thereof.

33. The system according to claim 19, wherein said computing device is further configured to color code said terrain elevation data of said first topographical model in accordance with a classification of terrain thereof.

34. The system according to claim 33, wherein said plurality of content types comprises a sinkholes, trenches, hyperbolic terrain, planar terrain, ridges, and mounds.

35. The system according to claim 19, wherein said first topographical model comprises at least one difference indication indicating a change of a scene's content.

36. The system according to claim 35, wherein said plurality of content types comprises objects that are new to a scene, objects that are removed from a scene, objects whose size has increased or decreased.
